(19) United States
(12) Patent Application Publication
(10) Pub. No.: US 2025/0100833 A1
(43) Pub. Date: Mar. 27, 2025

(54) FURTHER METHODS AND APPARATUSES FOR DISPENSING AND EXPANDING EXPANDABLE SLIT SHEET MATERIAL

(71) Applicant: David Paul Goodrich, Sedona, AZ (US)

(72) Inventor: David Paul Goodrich, Sedona, AZ (US)

(21) Appl. No.: 18/974,505

(22) Filed: Dec. 9, 2024

Related U.S. Application Data
(63) Continuation-in-part of application No. 17/239,682, filed on Apr. 25, 2021.
Application No. 17/239,682 is a continuation-in-part of application No. 16/749,875, filed on Jan. 22, 2020, now Pat. No. 11,691,374.
(60) Provisional application No. 63/015,610, filed on Apr. 26, 2020.
(60) Provisional application No. 62/795,310, filed on Jan. 22, 2019.

(51) Int. Cl. B65H 23/182; B31D 1/00; B65H 16/00

(52) U.S. Cl. CPC B65H 23/182; B31D 1/0031; B65H 16/005; B31D 2205/007; B65H 2701/1944

(57) ABSTRACT

According to some embodiments, methods of adjusting frictional resistance of an expandable slit sheet paper dispensed from a manual dispenser include, e.g.: supporting a roll of expandable slit sheet paper on a frame of the dispenser, said roll of expandable slit sheet paper having an initial diameter; manually pulling a distal end of the roll of expandable slit sheet paper from a perimeter of said roll such that the expandable slit sheet paper extends along an arc around a portion of a periphery of at least one bar that extends across a width of said expandable slit sheet paper, whereby applying a frictional resistance to the expandable slit sheet paper that causes said expandable slit sheet paper to expand and form open cells; and after dispensing expandable slit sheet paper from said roll such that a diameter of said roll is reduced from said initial roll diameter, adjusting said frictional resistance to the expandable slit sheet paper that causes said expandable slit sheet paper to expand and form open cells by altering a path of the expandable slit sheet paper around said at least one bar such as to increase the frictional resistance applied to the expandable slit sheet paper.

The present application is 1) a nonprovisional of U.S. Application Ser. No. 63/608,292, filed Dec. 10, 2023 and 2) a continuation-in-part of U.S. application Ser. No. 17/239,682, filed Apr. 25, 2021, which '682 application is a non-provisional of U.S. Provisional Application No. 63/015,610, filed Apr. 26, 2020, and which '682 application is a continuation-in-part of U.S. application Ser. No. 16/749,875, filed Jan. 22, 2020 (now U.S. Pat. No. 11,691,374, issued on Jul. 4, 2023), which '875 application is a non-provisional of U.S. Provisional Application No. 62/795,310, filed Jan. 22, 2019, the disclosures of which prior applications are all incorporated herein by reference in their entireties.

### BACKGROUND

### Field

The preferred embodiments of the present invention relate to the use of a tensioning device for applying resistance to the dispensing of slit sheet material thereby expanding the slit sheet material.

### INCORPORATIONS BY REFERENCE

Further information relating to the paper which can be used in the present invention, slit patterns, and the expansion process is found in U.S. Pat. Nos. 5,538,778; 5,667,871; 5,688,578; and 5,782,735; 3,908,071; 14/901977; WO1984002936A1; US20020060034; US 2007/0240841 A1; 3,104,197; 3,220,116; 3,266,972; 3,269,393; 3,908,071; 6,024,832; U.S. Pat. No. 6,458,447 B1; and U.S. Pat. No. 6,712,930 B2; the disclosures of which are incorporated by reference herein, as though recited in full.

This application incorporates by reference herein, as though recited in full, the disclosures of publication No. US 2018/0222665, and publication No. US 2018/0127197.

### Description of the Related Art

There have been a number of devices to dispense expanded slit sheetmaterial that are motorized for powered dispensing and manual devices that must provide a tensioning method. For example, Geami WrapPak® ExBox is a self-contained, disposable, and recyclable combination of die cut Kraft paper and tissue interleaf that in combination is used to cushion and protect fragile items during shipment.

### SUMMARY OF THE PREFERRED EMBODIMENTS

The preferred embodiments overcome problems in the above and/or other background art.

Another notable aspect according to some preferred embodiments of the present invention is to create a lightweight expanded slit sheet made from paper using a paper dispenser that provides for the expansion of a slit sheet of paper.

In accordance with one illustrative broad embodiment of the invention, a dispenser is provided for expanding slit paper in which a roll of slit sheet material can be installed without removing any parts during each roll change.

### Embodiment 1

According to some illustrative embodiments, a device for dispensing expandable slit sheet paper is provided that includes: a roll of expandable slit sheet paper, an interior core member, wherein said roll of expandable slit sheet paper is wound on said interior core member, means for variably applying a frictional resistance to the rotation of said core member by varyingly applying pressure on an interior of said core member, such as, in some embodiments, with a rigid pressure member.

In some implementations, the device further includes reciprocating mechanism for reciprocating the rigid pressure member. In some examples, the reciprocating mechanism includes a rotatable cam. In some examples, the rigid pressure member includes a reciprocated shim. In some examples, the shim includes a curved outer surface that is movable towards and away from the inside surface of the core. In some examples, the shim has a radius of curvature similar to that of the core. In some examples, there is less than 3 shims. In some examples, there is one shim such that pressure is applied in a single region by a surface of the one shim.

In various embodiments, one or more of the various features described herein-below in relation to Embodiment 1 or in relation to other Embodiments can be employed within this embodiment.

### Embodiments 2 and 4

According to some other illustrative embodiments, a device for dispensing expandable slit sheet paper is provided that includes: a roll of expandable slit sheet paper, an interior core member, wherein said roll of expandable slit sheet paper is wound on said interior core member, a core-attachment member configured to be fixed to the core for rotation with the core during use, means for variably applying a frictional resistance to the rotation of said core member by varyingly applying pressure directly or indirectly to the core-attachment member.

In some examples, the means for variably applying a frictional resistance to the rotation of said core member by varyingly applying pressure directly or indirectly to the core-attachment member applies pressure directly to the core-attachment member. In some examples, the core-attachment member is configured to be inserted at least partly within the interior of the core. In some examples, the core-attachment member is press-fit within the core. In some examples, the core-attachment member is secured to the core by one or more projectable member that extends outwardly to grip an interior of the core. In some examples, the means for variably applying a frictional resistance to the rotation of said core member by varyingly applying directly or indirectly to the core-attachment member includes variably applying pressure with a rigid pressure member. In some examples, the device further includes a reciprocating mechanism for reciprocating the rigid pressure member. In some examples, the reciprocating mechanism includes a rotatable cam. In some examples, the rigid pressure member includes a reciprocated shim. In some examples, the shim includes a curved outer surface that is movable towards and away from the inside surface of the core. In some examples, the shim has a radius of curvature similar to that of the core. In some examples, there are less than 3 shims. In some examples, there is one shim such that pressure is applied in a single region by a surface of the one shim.

In various embodiments, one or more of the various features described herein-below in relation to Embodiment 2 or 4 or in relation to other Embodiments can be employed within this embodiment.

### Embodiment 3

According to some other illustrative embodiments, a device for dispensing expandable slit sheet paper is provided that includes: a roll of expandable slit sheet paper, an interior core member, wherein said roll of expandable slit sheet paper is wound on said interior core member, means for applying a frictional resistance to the rotation of said core member by applying pressure or resistance to at least one face surface of the expandable slit sheet paper.

In some examples, the device further includes at least one roll that is configured to be moved against a face surface of the expandable slit sheet paper. In some examples, the device further includes a pair of opposing rolls that are configured to apply resistant to the paper after exiting the roll. In some examples, the device further includes at least one roll that is adapted to be moved towards a face of the paper. In some examples, the device further includes at least one roll that is adapted to be moved towards a face of the paper after extending from the paper roll.

In various embodiments, one or more of the various features described herein-below in relation to Embodiment 3 or in relation to other Embodiments can be employed within this embodiment.

According to some other illustrative embodiments, a device for dispensing expandable slit sheet paper is provided that includes: a roll of expandable slit sheet paper, a frame configured to rotatably support the roll of expandable slit sheet paper; a plurality of rollers configured to receive an end of the expandable slit sheet paper; at least one of said plurality of rollers being configured to apply resistance to the expandable slit sheet paper, whereby when the expandable slit sheet paper is manually pulled from a distal end of the expandable slit sheet paper, said expandable slit sheet paper is expanded.

In some examples, the plurality of rollers includes a pair of rollers, said pair of rollers being arranged such that the expandable slit sheet paper is passed in between said pair of rollers. In some examples, at least one of said pair of rollers is movable with respect to said expandable slit sheet paper. In some examples, an upper one of said pair of rollers is movable with respect to said expandable slit sheet paper. In some examples, said expandable slit sheet paper is configured to follow an S-curve between said pair of rollers, with said expandable slit sheet paper extending in an arc around at least a portion of a periphery of at least one of said pair of rollers. In some examples, said expandable slit sheet paper is configured to extend underneath and past a bottom of a lower one of said pair of rollers, around a front side of said lower one of said pair of rollers, backwardly between said pair of rollers, and around and over the top of an upper one of said pair of rollers. In some examples, the distal end of the expandable slit sheet paper is configured to be manually grasped after passing around and over the top of the upper one of said pair of rollers. In some examples, said roll of expandable slit sheet paper is supported on a rod that extends through a center of said roll, and wherein said frame includes at least one lateral side member configured to support said rod. In some examples, said frame includes two lateral side members configured to removably support opposite ends of said rod. In some examples, said two lateral side members include receiving slots configured to removably support said rod. In some examples, said lateral side members are made of metal. In some examples, said lateral side members are made of steel. In some examples, said device is configured to convey at least one additional layer of sheet material. In some examples, said at least one additional layer of sheet material includes an interleaf layer. In some examples, said at least one additional layer of sheet material includes an additional expandable slit sheet paper layer. In some examples, said device further includes a mechanism for adjusting the resistance applied by said at least one of said plurality of rollers to said expandable slit sheet paper. In some examples, said mechanism for adjusting includes manually rotated member that increases or decreases resistance applied to the expandable slit sheet paper based on the rotational position of said manually rotated member. In some examples, said expandable slit sheet paper is made with an extensible paper. In some examples, said extensible paper has an extensibility in a machine direction of greater than 3%. In some examples, said extensible paper has an extensibility of between about 3-20% in a machine direction. In some examples, said extensible paper has an extensibility of between about 3-9% in a machine direction.

In various embodiments, one or more of the various features described herein-below in relation to Embodiment 3 or in relation to other Embodiments can be employed within this embodiment.

### Additional Variations and Embodiments

According to some further embodiments, a method of adjusting frictional resistance of an expandable slit sheet paper dispensed from a manual dispenser is performed that includes:
supporting a roll of expandable slit sheet paper on a frame of the dispenser, the roll of expandable slit sheet paper having an initial diameter;
manually pulling a distal end of the roll of expandable slit sheet paper from a perimeter of the roll such that the expandable slit sheet paper extends along an arc around a portion of a periphery of at least one bar that extends across a width of the expandable slit sheet paper, whereby applying a frictional resistance to the expandable slit sheet paper that causes the expandable slit sheet paper to expand and form open cells; and
after dispensing expandable slit sheet paper from the roll such that a diameter of the roll is reduced from the initial roll diameter, adjusting the frictional resistance to the expandable slit sheet paper that causes the expandable slit sheet paper to expand and form open cells by altering a path of the expandable slit sheet paper around the at least one bar such as to increase the frictional resistance applied to the expandable slit sheet paper.

According to some examples, the method further includes altering the path of the expandable slit sheet paper around the at least one bar such as to increase the frictional resistance applied to the expandable slit sheet paper by:
a) manually altering the path of the expandable slit sheet paper around the at least one bar such as to increase the frictional resistance applied to the expandable slit sheet paper; and/or
b) adjusting a position of at least one of the at least one bars such as to increase the frictional resistance applied to the expandable slit sheet paper.

According to some other embodiments, a method of adjusting frictional resistance of an expandable slit sheet paper dispensed from a manual dispenser includes:
supporting a roll of expandable slit sheet paper on a frame of the dispenser, the roll of expandable slit sheet paper having an initial diameter;
manually pulling a distal end of the roll of expandable slit sheet paper from a perimeter of the roll such that the expandable slit sheet paper extends along an arc around a portion of a periphery of at least one bar that extends across a width of the expandable slit sheet paper, whereby applying a frictional resistance to the expandable slit sheet paper that causes the expandable slit sheet paper to expand and form open cells; and
after dispensing expandable slit sheet paper from the roll such that a diameter of the roll is reduced from the initial roll diameter, adjusting the frictional resistance to the expandable slit sheet paper that causes the expandable slit sheet paper to expand and form open cells by:
a) manually altering a path of the expandable slit sheet paper around the at least one bar such as to increase the frictional resistance applied to the expandable slit sheet paper; and/or
b) adjusting a position of at least one of the at least one bars such as to increase the frictional resistance applied to the expandable slit sheet paper.

According to some examples, the method further includes after dispensing expandable slit sheet paper from the roll such that a diameter of the roll is reduced from the initial roll diameter, adjusting the frictional resistance applied to the expandable slit sheet paper that causes the expandable slit sheet paper to expand and form open cells by manually altering a path of the expandable slit sheet paper around the at least one bar such as to increase the frictional resistance applied to the expandable slit sheet paper.

According to some examples, the method further includes the manually altering a path of the expandable slit sheet paper around the at least one bar such as to increase the frictional resistance applied to the expandable slit sheet paper includes:
the at least one bar including a plurality of bars;
initially manually pulling a distal end of the roll of expandable slit sheet paper from a perimeter of the roll such that the expandable slit sheet paper extends along an arc around a portion of a periphery of a first bar of the plurality of bars, whereby applying a first frictional resistance to the expandable slit sheet paper that causes the expandable slit sheet paper to expand and form open cells; and
after dispensing expandable slit sheet paper from the roll such that a diameter of the roll is reduced from the initial diameter, manually redirecting the distal end of the roll of expandable slit sheet paper such that the expandable slit sheet paper extends along an arc around a portion of a periphery of one of the plurality of bars and then extends along an arc around a portion of a periphery of another of the plurality of bars, whereby applying a second frictional resistance to the expandable slit sheet paper, greater than the first frictional resistance, that causes the expandable slit sheet paper to expand and form open cells.

According to some examples, the method further includes that the one of the plurality of bars is the same as the first bar of the plurality of bars.

According to some examples, the method further includes that after dispensing expandable slit sheet paper from the roll such that a diameter of the roll is reduced from the initial diameter, adjusting the frictional resistance applied to the expandable slit sheet paper that causes the expandable slit sheet paper to expand and form open cells by adjusting a position of at least one of the at least one bars such as to increase the frictional resistance applied to the expandable slit sheet paper.

According to some examples, the method further includes that after dispensing expandable slit sheet paper from the roll such that a diameter of the roll is reduced from the initial diameter, adjusting the frictional resistance applied to the expandable slit sheet paper that causes the expandable slit sheet paper to expand and form open cells by adjusting a position of at least one of the at least one bars such as to increase the frictional resistance applied to the expandable slit sheet paper.

According to some examples, the method further includes that the at least one bar includes a pair of bars.

According to some examples, the method further includes that after dispensing expandable slit sheet paper from the roll such that a diameter of the roll is reduced from the initial diameter, adjusting a position of one of the pair of bars with respect to the frame.

According to some examples, the method further includes that after dispensing expandable slit sheet paper from the roll such that a diameter of the roll is reduced from the initial diameter, adjusting a position of each of the pair of bars with respect to the frame.

According to some examples, the method further includes extending the expandable slit sheet paper in an S-curve configuration around the pair of bars, with the expandable slit sheet paper extending in respective arcs around at least portions of peripheries of each bar of the pair of bars.

According to some examples, the method further includes extending the expandable slit sheet paper underneath and past a bottom of a lower one of the pair of bars, around a front side of the lower one of the pair of bars, backwardly between the pair of bars, and around and over the top of an upper one of the pair of bars.

According to some examples, the method further includes that the bars have curved peripheries.

According to some examples, the method further includes that the bars have substantially cylindrical peripheries.

According to some examples, the method further includes that the bars are made with metal.

According to some examples, the method further includes that the bars are non-rotatably supported on the frame.

According to some examples, the method further includes that the bars are rotatably supported on the frame.

According to some examples, the method further includes that the curved peripheries of the bars have friction surfaces that impart a frictional resistance to the expandable slit sheet paper.

According to some embodiments, a device for dispensing expandable slit sheet paper is provided that includes:
a roll of expandable slit sheet paper,
a frame configured to rotatably support the roll of expandable slit sheet paper;
at least one bar arranged to receive an end region of the expandable slit sheet paper such that the expandable slit sheet paper extends around a peripheral surface of the at least one bar that applies frictional resistance to the expandable slit sheet paper, whereby when the expandable slit sheet paper is manually pulled from a distal end of the expandable slit sheet paper the expandable slit sheet paper is expanded, and
wherein a position of the at least one bar relative to the frame is adjustable such as to adjust the frictional resistance applied to the expandable slit sheet paper.

According to some examples, the device further includes that the at least one bar includes a pair of bars, the pair of bars being arranged such that the expandable slit sheet paper is passed in between the pair of bars.

According to some examples, the device further includes that one of the pair of bars is movable with respect to the frame.

According to some examples, the device further includes that each of the pair of bars is movable with respect to the frame.

According to some examples, the device further includes that the expandable slit sheet paper is configured to follow an S-curve around the pair of bars.

According to some examples, the device further includes that the expandable slit sheet paper is configured to extend underneath and past a bottom of a lower one of the pair of bars, around a front side of the lower one of the pair of bars, backwardly between the pair of bars, and around and over the top of an upper one of the pair of bars.

According to some examples, the device further includes that the distal end of the expandable slit sheet paper is arranged to be manually grasped after passing around and over the top of the upper one of the pair of bars.

According to some examples, the device further includes that the roll of expandable slit sheet paper is supported on a core that extends through a center of the roll, and wherein the frame includes at least one lateral side member configured to support the core.

According to some examples, the device further includes that the frame includes two lateral side members configured to removably support opposite ends of the core.

According to some examples, the device further includes that the lateral side members are made of metal.

According to some embodiments, a method of manually dispensing and expanding an expandable slit sheet paper is performed that includes:
providing a dispenser for expandable slit sheet material having at least one sidewall and having a plurality of bars supported on the at least one sidewall;
supporting a roll of expandable slit sheet paper on the frame, the roll of expandable slit sheet paper being wound around a central core member and having an initial diameter;
manually pulling a distal end of the roll of expandable slit sheet paper from a perimeter of the roll such that the expandable slit sheet paper extends along an arc around a portion of a periphery of a first of the plurality of bars, whereby applying a first frictional resistance to the expandable slit sheet paper causing the expandable slit sheet paper to expand and form open cells; and
after dispensing expandable slit sheet paper from the roll such that a diameter of the roll is reduced, manually redirecting the distal end of the roll of expandable slit sheet paper such that the expandable slit sheet paper extends along an arc around a portion of a periphery of one of the plurality of bars and then extends around an arc around a portion of a periphery of another of the plurality of bars, whereby applying a second frictional resistance applied to the expandable slit sheet paper, that is greater than the first frictional resistance, that causes the expandable slit sheet paper to expand and form open cells.

### Embodiment 5

According to some illustrative embodiments, a device for dispensing expandable slit sheet paper is provided that includes: a roll of expandable slit sheet paper, an interior core member, wherein said roll of expandable slit sheet paper is wound on said interior core member, means for variably applying a frictional resistance by: a) varyingly applying resistance at at least one face surface of the expandable slit sheet paper; b) variably applying a frictional resistance to the rotation of said core member by varyingly applying pressure on an interior of said core member with a rigid pressure member; c) variably applying a frictional resistance to the rotation of said core member by varyingly applying pressure directly or indirectly to a core-attachment member; and/or d) otherwise variably applying a frictional resistance that resists rotation of the roll and/or movement of said expandable slit sheet paper; and wherein said means for variably applying a frictional resistance includes an automation mechanism for automated control of the frictional resistance.

In some examples, the automation mechanism includes a computer or controller. In some examples, the automation mechanism includes a mechanism for manually setting a desired resistance which is imparted via the automation mechanism. In some examples, the mechanism for manually setting includes a manual dial, a key pad or other input device.

In various embodiments, various features described herein related to Embodiment 5 can be employed within the context of any of the embodiments described herein.

The above and/or other aspects, features and/or advantages of various embodiments will be further appreciated in view of the following description in conjunction with the accompanying figures. Various embodiments can include and/or exclude different aspects, features and/or advantages where applicable. In addition, various embodiments can combine one or more aspect or feature of other embodiments where applicable. The descriptions of aspects, features and/or advantages of particular embodiments should not be construed as limiting other embodiments or the claims.

### BRIEF DESCRIPTION OF THE DRAWINGS

The preferred embodiments of the present invention are described by a way of example, and not limitation, in relation to the accompanying figures, in which:

FIGS. 1-4 show a first embodiment, wherein:

FIG. 1 is a perspective view of the bar-type expander system that comprises an L-shaped frame non-rotationally affixed to a sleeve holder;

FIG. 2 is a perspective view of a sleeve as it sits on the sleeve holders as shown in FIG. 1 and a shim member is shown in the up position through an opening in the sleeve;

FIG. 3 is a perspective view of the paper roll/paper core mounted on and affixed to the sleeve; and

FIG. 4 is a side view of the friction system in which a rotatable shaft turns the cam block to raise or lower the shim member.

FIGS. 5-9 show a second embodiment, wherein:

FIG. 5 is a perspective view of an interior core insert member;

FIG. 6 is a perspective view of the core insert member resting on a puck that supports the core insert member on the dispenser;

FIG. 7 is a perspective view of the core insert member resting on a puck with a tension bar positioned to apply pressure to the core insert member;

FIG. 8 is a perspective view of the core insert member fully inserted into the paper core with the tension bar in contact with the core insert member; and

FIG. 9 is a perspective view of the paper roll as part of the assembly.

FIG. 10 shows a third embodiment, in which FIG. 10 is a perspective view of a nip roller dispensing system where a roll of slit sheet paper sits on a rod in a frame, is fed through a pair of rubberized rotational resistance rollers 1006, and exits expanded.

FIGS. 11-12 show a fourth embodiment of the invention similar to that of the first embodiment of FIGS. 1-4, along with an intermediate sleeve.

FIGS. 13-14 show other embodiments of the invention in which an automated tensioning mechanism is provided.

FIGS. 15-16 show other embodiments in which resistance rollers are employed according to some embodiments.

FIGS. 17-20 are schematic diagrams depicting expandable slit sheet material layers in some illustrative embodiments.

FIGS. 21-25 show other embodiments employing an S curve manner of dispensing.

FIGS. 26 and 27 show illustrative expandable slit sheet material employed in some embodiments of the invention.

FIGS. 28A-28F show novel systems and methods according to another embodiment, wherein:

FIG. 28A is a perspective view of an illustrative dispenser situated on a table surface adjacent a roll of expandable slit sheet paper;

FIG. 28B is a perspective view of the dispenser shown in FIG. 28A with the roll shown in FIG. 28A supported on the dispenser and with a user grasping a distal end of the expandable slit sheet paper on roll;

FIG. 28C is a perspective view of the dispenser shown in FIG. 28B with the user directing the distal end of the expandable slit sheet paper from said roll over a lower bar of a pair of bars;

FIG. 28D is a perspective view of the dispenser shown in FIG. 28C with the user directing the distal end of the expandable slit sheet paper from said roll over the lower bar of the pair of bars, expanding the expandable slit sheet paper downstream of the lower bar, and wrapping the expandable slit sheet paper around an item;

FIG. 28E is a perspective view of a dispenser similar to that shown in FIGS. 28A-28D, wherein the roll has a reduced diameter and with the user directing the expandable slit sheet paper from said roll to extend over the upper bar, back in between the pair of bars, forward beneath the lower bar, and expanding the expandable slit sheet paper downstream of the lower bar, and wrapping the expandable slit sheet paper around an item;

FIG. 28F is a perspective view of the dispenser of FIG. 28E, adjacent with the item that has been wrapped and separated by the user.

FIGS. 29A-29B are side views of a dispenser according to another illustrative embodiment of the invention in which a path followed by the expandable slit sheet paper around a pair of cross-bars is altered over time during dispensing such as to vary the tension applied during dispensing by adjusting the positions of the pair of cross-bars upon the dispenser, wherein:

FIG. 29A shows the dispenser with the pair of bars in an initial lower position; and

FIG. 29B shows the dispenser with the pair of bars in a subsequent raised position after the diameter of the roll of expandable slit sheet paper is reduced.

FIGS. 30A-30B depict an illustrative track structure according to an illustrative embodiment, wherein:

FIG. 30A is a perspective view of a portion of a dispenser depicting the illustrative track structure;

FIG. 30B is an explanatory side view of the elements of the portion of the dispenser shown in FIG. 30A as seen from the direction of the arrows 30b-30b shown in FIG. 30A.

FIG. 31 is a perspective view of a portion of a dispenser depicting an illustrative track structure according to another illustrative embodiment.

FIGS. 32A-32B depict an illustrative track structure according to another illustrative embodiment, wherein:

FIG. 32A is a perspective view of a portion of a dispenser depicting the illustrative track structure;

FIG. 32B is an explanatory side view of the elements of the portion of the dispenser shown in FIG. 30A as seen from the direction of the arrows 32b-32b shown in FIG. 32A.

FIG. 33 is a side view of a dispenser according to another illustrative embodiment of the invention in which a path followed by the expandable slit sheet paper around a pair of cross-bars is altered over time during dispensing such as to vary the tension applied during dispensing by adjusting the positions of one of bars of the pair of cross-bars upon the dispenser, such as to follow a generally horizontal path.

FIG. 34 is a side view of a dispenser according to another illustrative embodiment of the invention in which a path followed by the expandable slit sheet paper around a pair of cross-bars is altered over time during dispensing such as to vary the tension applied during dispensing by adjusting the positions of one of bars of the pair of cross-bars upon the dispenser, such as to follow a path angled to vertical and horizontal directions.

FIG. 35 is a side view of a dispenser according to another illustrative embodiment of the invention in which a path followed by the expandable slit sheet paper around a cross-bar is altered over time during dispensing such as to vary the tension applied during dispensing by adjusting the positions of the cross-bar such as to follow a generally vertical path.

FIG. 36 is a side view of a dispenser according to another illustrative embodiment of the invention in which a path followed by the expandable slit sheet paper around a cross-bar is altered over time during dispensing such as to vary the tension applied during dispensing by adjusting the positions of the cross-bar such as to follow a generally curved path.

FIG. 37 is a side view of a dispenser according to another illustrative embodiment of the invention in which a path followed by the expandable slit sheet paper around a cross-bar is altered over time during dispensing such as to vary the tension applied during dispensing by adjusting the positions of the cross-bar such as to follow a generally curved path around a pivot arm.

FIG. 38 is a side view of a dispenser according to another illustrative embodiment of the invention in which a path followed by the expandable slit sheet paper around a cross-bar is altered over time during dispensing such as to vary the tension applied during dispensing by automatically mechanically adjusting the positions of the cross-bar such as to follow a generally vertical path.

FIG. 39 is a side view of a dispenser according to another illustrative embodiment of the invention in which a path followed by the expandable slit sheet paper around a cross-bar is altered over time during dispensing such as to vary the tension applied during dispensing by automatically mechanically adjusting the positions of the cross-bar such as to follow a generally curved path.

FIG. 40 is a side view of a dispenser according to another illustrative embodiment of the invention in which a path followed by the expandable slit sheet paper around a cross-bar is altered over time during dispensing such as to vary the tension applied during dispensing by automatically mechanically adjusting the positions of the cross-bar using an automated control system.

### DETAILED DESCRIPTION OF THE PREFERRED EMBODIMENTS

While the present invention may be embodied in many different forms, the illustrative embodiments are described herein with the understanding that the present disclosure is to be considered as providing examples of the principles of the invention and that such examples are not intended to limit the invention to preferred embodiments described herein and/or illustrated herein.

### Illustrative Expandable Slit Sheet Paper:

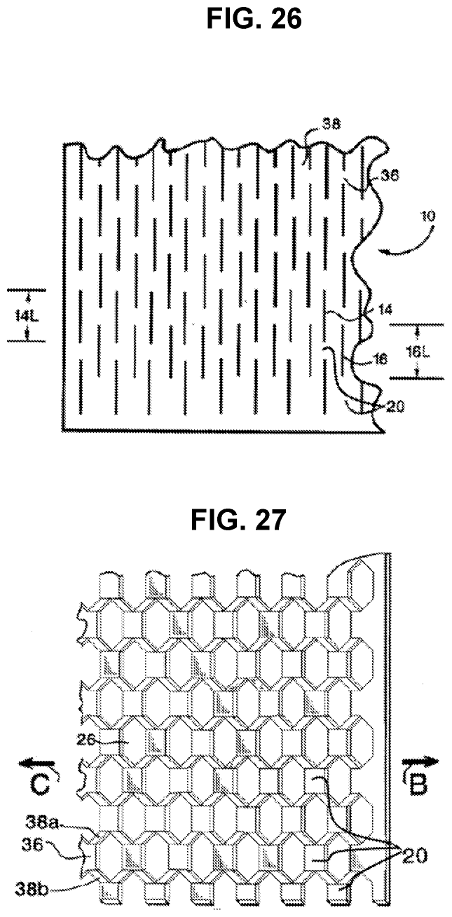

FIG. 26 is a plan view of an illustrative expandable slit sheet paper in an unexpanded state, and FIG. 27 is a plan view of the illustrative expandable slit sheet paper in an expanded state, which illustrative paper can be employed for expansion in illustrative embodiments of the present invention.

FIGS. 26 and 27 depict an illustrative expandable slit sheet paper that can be expanded with systems and methods of the present invention in some illustrative embodiments of the invention. Towards that end, FIG. 26 is an illustration of an exemplary slit pattern in an illustrative expanded slit sheet. The expandable slit sheet paper shown in FIG. 26 operates as an expandable cell-forming paper that can be expanded to an expanded state as shown in FIG. 27. FIG. 26 shows an illustrative section of an expandable slit sheet 10 in an unexpanded (unopened) state, with staggered rows of slits 14 and 16 that extend entirely through the width of the sheet 10, and land portions 20 extending between adjacent slits within rows 14 and 16. As shown in FIG. 26, in some preferred embodiments, the slit lengths 14L and 16L are uniform across the face of the sheet 10; similarly, the distance and area of each row spacing 38 (i.e., between adjacent rows) and each slit spacing 36 (i.e., between adjacent slits) are also uniform. Although an expandable slit sheet can be formed with a variety of slit patterns, the illustrative example shown in FIGS. 26 and 27 depict an illustrative example to scale with illustrative lengths of slits, spacing between slits, proportional relationships of sizes of created hexagonal cells, land portions and leg portions, etc., according to some illustrative examples with such as drawings being to scale in some illustrative and non-limiting embodiments. In FIG. 27, the sheet 10 shown in FIG. 26 has been subjected to an expansion force in the direction of arrows B and C and opened to an open cell formation. In that regard, in this illustrated example, the open cell formation results in hexagonal shaped cells as shown in FIG. 27. In particular, as depicted, the slits 14 and 16 are in an opened state in which the sheet 10 is oriented to have an array of three-dimensional hexagonal cells 26, with substantially rectangular land portions 20 within the slit spacings 36 situated at an inclined angle (i.e., such as to be transverse to the original plane of the sheet 10), and the leg portions 38a and 38b connecting the land portions between the row spacings having been warped to, e.g., slightly less than a 90° angle to the original plane of the sheet. The leg portions 38a and 38b are basically mirror images of one another and connect the land portions 20 such as to form the three-dimensional hexagonal cells.

In the preferred embodiments, systems and methods of the preferred embodiments of the present invention can be employed for expanding an expandable slit sheet similar to that shown in FIGS. 26 and 27.

### Extensible Paper Employed in Some Preferred Embodiments:

In some more preferred embodiments, the expandable slit sheet paper is made with an extensible paper. In some most preferred embodiments, extensible papers as set forth in the present inventor's U.S. Pat. No. 10,669,086 are employed, the entire disclosure of which is incorporated herein by reference.

According to some embodiments, the extensible paper is extensible in a machine direction in a range of at least 5%. According to some embodiments, the extensible paper is extensible in a cross direction in a range of at least 5%. According to some embodiments, the extensible paper is extensible in a machine direction in a range of at least 5% and in a cross direction in a range of at least 5%. According to some embodiments, the extensible paper is extensible in a machine direction in a range of at least 6% and in a cross direction in a range of at least 6%. According to some embodiments, the extensible paper is extensible in a machine direction in a range of at least 7% and in a cross direction in a range of at least 7%. According to some, most preferred, embodiments, the extensible paper is extensible in a machine direction in a range of at least 8% and in a cross direction in a range of at least 8%. According to some embodiments, the extensible paper is extensible in a machine direction in a range of between 5% to 15% and in a cross direction in a range of between 5% to 15%. According to some embodiments, the extensible paper is extensible in a machine direction in a range of between 7% to 15% and in a cross direction in a range of between 7% to 15%.

According to some illustrative embodiments, the plurality of slits each have a width of between 0.35 and 0.65 inches; according to some embodiments, the plurality of slits each have a width of between 0.45 and 0.55 inches. According to some embodiments, the plurality of slits each have a width of about 0.5 inches. According to some embodiments, the plurality of slits each have a width of less than 0.5 inches. According to some embodiments, the plurality of slits each have a width of less than 0.45 inches. According to some embodiments, the plurality of slits each have a width of less than 0.4 inches.

In some more preferred embodiments, extensible papers as set forth in the above-referenced U.S. Pat. No. 10,669,086 are employed. Towards that end, the following paragraphs (in quotations) under this section are quoted from the '086 patent set forth details of extensible papers according to some preferred embodiments that can be employed in preferred embodiments of the present invention.

“For the purposes of the present invention, the term ‘extensible’ as applied to paper sheets, means a paper sheet that is able to stretch in a longitudinal direction of the paper sheet upon applying a force in the longitudinal direction of the paper sheet. Illustrative extensible sheets are disclosed in U.S. Pat. No. 3,908,071, U.S. patent application Ser. No. 14/901,977 (U.S. Pat. No. 9,945,077), International Application No. WO 1984002936, U.S. Publication Nos. 2002/0060034, 2007/0240841 (U.S. Pat. No. 7,918,966), and U.S. Pat. Nos. 3,104,197, 3,220,116, 3,266,972, 3,269,393, 3,908,071, 6,024,832, 6,458,447, and 6,712,930, the entire disclosures of which are incorporated by reference herein, as though recited in full. It should be understood that the stretching of an extensible paper must be measured in an unslit sheet of paper. As disclosed in U.S. Pat. No. 3,266,972, the test and characterization procedures employed in measuring elongation (extensibility) properties can be in accordance with standard TAPPI test Elongation T457. In addition, as disclosed in U.S. Pat. No. 3,266,972, the expression ‘extensible papers’ means a paper having an increasable elongation in the machine direction as compared to standard, non-extensible Kraft paper.”

“In some preferred embodiments, extensible paper can be produced by varying the accumulation of paper fibers by essentially slowing the paper feeding process during the drying method to trap extra fibers that make the paper appear to have microscopically sized rows of paper that you would see if one were to pleat the paper. The difference is that extensible paper's microscopic rows are adhered to each other through the use of binders and other types of adhesives in conjunction with the drying process. Reference is made to patent U.S. Application No. 2007/0240841 (U.S. Pat. No. 7,918,966) where the purpose is to create a non-creped extensible paper that does not easily disconnect from itself. In addition, the surface of the extensible paper is still fairly flat.”

“In the preferred embodiments of the present invention, the extensible paper that is employed has low extensible properties as compared to other types of extensible papers. In this regard, an optimal extensible paper enables a smooth transition from an unexpanded to the expanded slit sheet by providing a small amount of stretching at the very start of expansion of the extensible slit sheet paper material.”

“In some exemplary constructions, during expansion of a slit sheet, the force required to initiate expansion is substantially higher than the force required to continue expansion. For example, once the paper initially starts to bend at the slits, the expansion continues more easily during continued bending at the slits. The force required to continue the expansion of the slit sheet during this continued bending is dramatically reduced beyond the above-noted initial expansion. In some preferred embodiments, the extensible slit sheet paper substantially reduces the force required to initiate expansion. On the other hand, in some preferred embodiments, during the above-noted continued expansion, the extensible paper does not substantially stretch simultaneously with the process of expanding the slit sheet paper; otherwise, the expanded sheet might not optimally be made into a cushioning wrap.”

“It should be noted that in this application, all theories related to functioning of the invention are provided to facilitate appreciation of concepts of the invention, rather than by way of limitation. Extensible paper, as designed, stretches as part of an increase in paper strength. In some embodiments, the functioning of the invention involves that the extensible slit sheet paper substantially utilizes the extensible property to ease the rotating the cells into the stretched shape and to resist tearing of the slit sheet during the expansion step. This means that at the initial point at which the cell rotates (i.e., initiating rotation between legs 38a and 38b on each side of the slit and land 20) the extensible slit sheet paper is substantially enhanced by the extensible paper's ability to stretch. In some embodiments, the functioning of the invention, thus, involves that extensible papers' properties are substantially utilized at this initial point and substantially finished as soon as the cell begins to rotate into its three-dimensional shape (i.e., after this initial point, the reliance on the extensible nature of the paper may be less substantial or even non-existent). After that initial point, the slit pattern properties, regardless of paper type, opens with greater ease to the point at which it forms a hexagon. Accordingly, in some embodiments, the extensible property substantially merely comes into play at the initial moment of expansion. In some other embodiments, while the extensible features of the paper comes into play most substantially at this initial point of rotation, the extensible features of the paper can have some affect during further expansion of the paper, whereby the initial point of expansion can be substantially facilitated due to extensibility and further expansion can also be, at least, somewhat facilitated due to extensibility.”

“In some of the preferred embodiments, preferable extensible papers that can be employed include extensible papers where the purpose of the extensible nature is to provide the type of stretching found for the use of multi-wall bags for heavy weight items like cement, or seed and the like. U.S. Patent Publication No. 2016/0355985 (U.S. application Ser. No. 14/901,997) and U.S. Pat. Nos. 3,104,197 and 3,266,972 teach the manufacture and properties of this form of extensible paper. Further teachings can be found in “Understanding sheet extensibility”, R. S. Seth, Pulp & Paper Canada T31, 106:2 (2005) III, pages 33-40 (T31-T38). The disclosures of the foregoing patents, patent publication, and printed publication are incorporated herein by reference, as though recited in full.”

“The prior expanded slit sheet art (See, e.g., U.S. Pat. Nos. 5,538,778, 5,667,871, 5,688,578, and 5,782,735) focused on paper strength to inhibit tearing during the expansion process and Kraft paper was satisfactory because the strength required coincided with the thickness required to make a satisfactory wrapping product. The increased strength of an expandable sheet does not contribute to or increase the value/performance of the expansion of the slit sheet material. It has now been found by the present inventor that an expandable slit sheet paper can be substantially improved by the use of an extensible sheet. In the preferred embodiments, this use of an extensible slit sheet paper advantageously provides a reduction in force required to open the slit sheet and therefore provides a faster and easier expanding process for the user of the expanded slit sheet. The unexpected benefit resulting from the reduction in force at the very start of the expansion of the slit sheet provides an unexpected improvement to the slit sheet packaging product and renders the employment of the extensible paper highly unique. Notably, the prior expanded slit sheet paper persisted in and was widely used in the marketplace for decades without the contemplation of the present invention or the potential advantages therefrom.”

“As set forth in this application, the present inventor has discovered that the force needed to expand an expandable slit sheet paper is far greater than the force required to expand an extensible slit sheet paper. By way of example, a 50 pound Kraft paper expandable slit sheet that is 15” wide prior to expansion requires approximately 4-6 pounds or 0.4 pounds per inch, whereas the force required to expand an extensible slit sheet of the same paper weight is 0.15-0.22 pounds per inch. This is a marked difference between the papers. Kraft paper has the strength to provide an acceptable expandable slit sheet. However, unexpectedly, the extensible slit sheet imparts an ease of expansion that greatly reduces the force required to expand the slit sheet, not based on the main purpose for extensible paper which is to increase its tensile strength but, rather, its capability to stretch. Since extensible paper is higher in cost and Kraft paper was strong enough, it was not previously known that extensible paper could be of benefit for making slit paper sheets of the types found in, e.g., U.S. Pat. Nos. 5,538,778, 5,667,871, 5,688,578, and 5,782,735, and U.S. Non-Provisional application Ser. No. 15/428,144. For example, it was not appreciated that an extensible slit sheet could have provided an equivalent strength to light weight, thin papers that previously had no applicability as a wrapping product. Light weight Kraft paper tears more easily than heavier weights of Kraft paper. It has now been found that the extensible paper enables the use of the lighter weight expanded slit-sheet papers that also advantageously provide gentler cushioning required by fragile items when a slit sheet is expanded, in contrast to the more rigid cushioning provided by heavier weight expanded slit-sheet papers.” “Reference is particularly made to the graph of Table 1 on page 5 of U.S. Patent Publication No. 2016/0355985 (now U.S. Pat. No. 9,945,077) as if recited in full, that describes paper strength based on certain manufacturing techniques. Within the graph is a column describing elongation at the point of paper break (or tearing of fibers) separated into two sub columns of the machine direction (MD) and cross direction (CD), also referred to as transverse direction. The elongation percentage of Table 1 ranges from 5.3% to 7.1% in the cross direction (CD) and 3.3% to 10.6% in the machine direction (MD).”

“Reference is also made to U.S. Pat. No. 3,266,972 within Table III of column 5 which references elongation in the percentage range from 3.7% to 4.6% in the CD or cross direction and 9.7% to 11.1% in the machine direction.”

“In both '985 and '972, the variations are based on the manufacturing process that places an emphasis on tensile strength and stretch in either the cross direction or machine direction accordingly.”

“The present inventor has discovered that for the purposes of expanding an extensible slit sheet paper for use as a packaging wrap and/or void fill, machine direction extensible ranges from 1%-9% provide an adequate extensibility, with 1% to 6% preferred, and 1% to 4% most highly preferred. The lower the extensibility coincides with lower costs of the paper per square foot. As indicated above, it should be understood that extensibility is measured on unslit paper.”

“In some alternative embodiments, machine direction extensibility ranges of the extendible slit sheet paper can have ranges of:
a) from 1.5%-9%, or more preferably from 1.5% to 6% preferred, or even more preferably from 1.5% to 4%; or
b) from 2%-9%, or more preferably from 2% to 6% preferred, or even more preferably from 2% to 4%; or
c) from 3%-9%, or more preferably from 3% to 6% preferred, or even more preferably from 3% to 4%.”

“For the purposes of expanding the slit sheet paper for use as a packaging wrap and/or void fill, it has been found that cross direction extensible ranges from 1%-5% provides an adequate extensibility with 1% to 4% preferred, and 1% to 3% most highly preferred.”

“In some alternative embodiments, cross direction extensibility ranges of the extendible slit sheet paper can have ranges of: a) from 1.5%-5%, or more preferably from 1.5% to 4%, or even more preferably from 1.5% to 3%; or b) from 2%-5%, or more preferably from 2% to 4%, or even more preferably from 2% to 3%.”

“In combination with the extensible paper, a smaller, lighter weight, and recyclable version of an expander can be employed (such as, e.g., made entirely or substantially entirely with recyclable cardboard in some illustrative embodiments). This expands the market to customers that use a very small amount of wrap as compared to the industrial market. It also provides for a less expensive expansion device to be employed for expanding the slit paper. Additionally, it enhances the ease of use by the packer by providing for less ripping during the wrapping process that occurs when the tension is not properly set. This occurs as the roll, during its continued use, becomes smaller and lighter in weight. As the roll of expanded slit sheet becomes lighter the tension required increases. Thus, there need for a varying tensioning method. With the use of the extensible paper, the tension required is significantly decreased and the strength of the paper is increased. Both benefit the person wrapping by making the tensioning required much less precise to the point at which, a single tension setting can be used with little or no adjustment. If the tension is set higher than necessary, the increase in strength from the extensible paper keeps the product from tearing and therefore makes it easier for the packer to use. Therefore, the packer can make fewer adjustments as the slit sheet roll becomes smaller and smaller.”

“The reduction in the force required to expand the slit paper enables a new product to be created using lighter weight papers. In the past, expanded slit sheet paper is primarily used as a wrapping product whereas its use as a void fill would be in limited circumstances due to void fill being typically the cheapest, that is, the lowest cost of all packaging products. The increased strength of the extensible sheet enables the use of a thinner and lighter weight slit sheet paper as a void fill product. If the expanded slit sheet is not being used as a wrap, then the thicker 0.005″, 50 pounds per 3,000 square feet paper and above is not required and a lighter weight 0.003-0.0045″ thick, 30-40 pounds per 3,000 square feet paper can be used as void fill. It can also be used to provide cushioning that other paper void fill products have not been able to provide. It has now been found that even though the extensible paper has a 10% higher price, the use of a thinner paper provides much more square footage per ton and more than compensates for the increased cost of the extensible paper as compared to Kraft paper.”

### First Embodiment

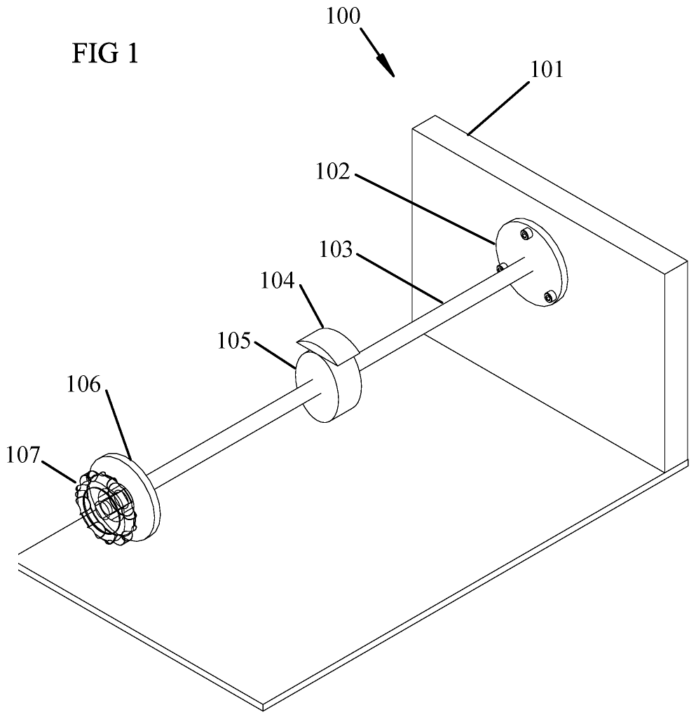

FIGS. 1 to 4 show a first embodiment of the present invention.

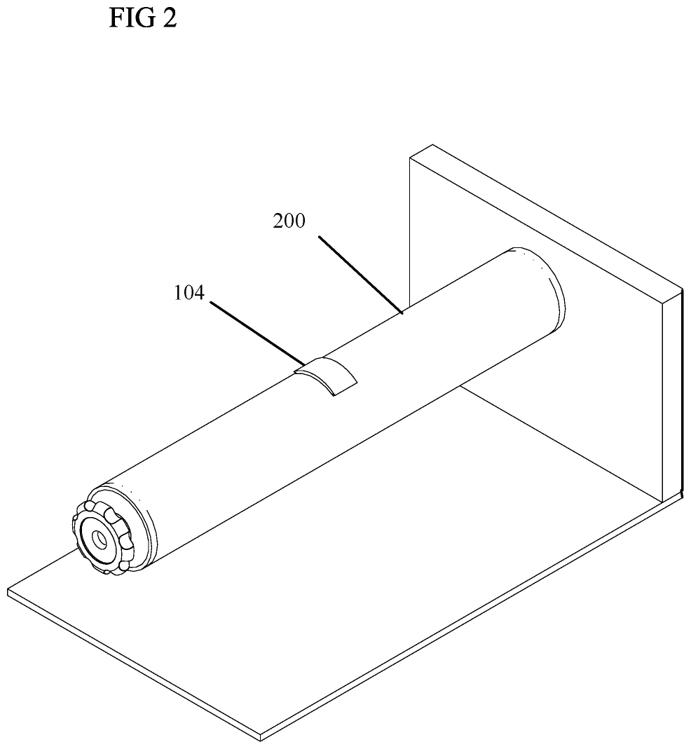

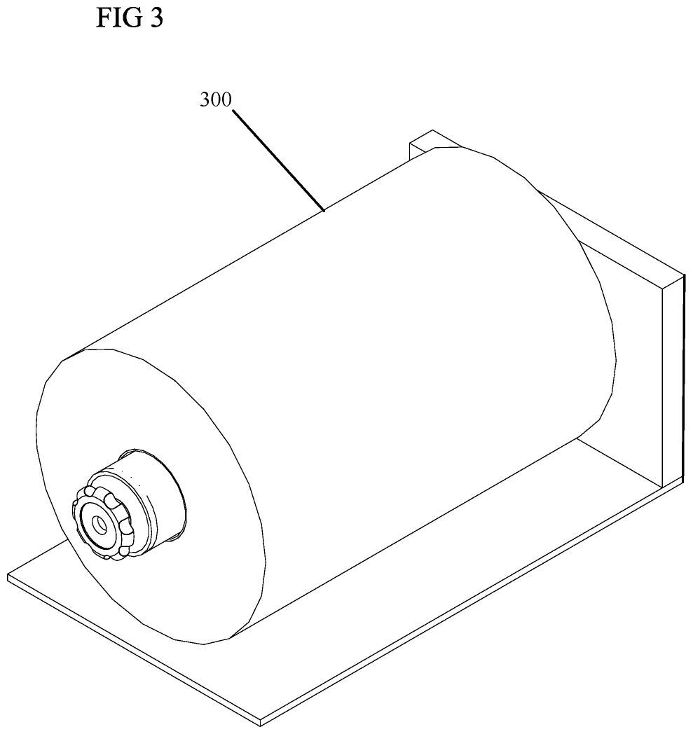

FIG. 1 is a perspective view of the bar-type expander system 100 that includes an L-shaped frame 101 non-rotationally affixes to a first sleeve holder plate 102. The first sleeve holder plate 102 together with the second sleeve holder plate106, respectively, affix a substantially cylindrical sleeve 200 (omitted in FIG. 1 to show internal parts, but shown in FIG. 2). The first sleeve holder plate 102 is fixed to the frame 101 (such as via bolts or the like as shown), and a shaft 103 is rotatably supported such as to extend from the plate 102 (such as, e.g., being rotatably received within a central opening within the plate 102). Along a central region of the shaft 103 is a CAM block 105 that is fixedly attached to the shaft in a manner to rotate with the rotation of the shaft 103 around a central axis of the shaft. Preferably, the CAM block is shaped with a non-circular outer peripheral shape whereby rotational movement of the CAM block around an axis of the shaft 103 will result in movement (e.g., raising and lowering) of the friction shim 104 that is, thus, caused to press against the internal paper core of within a roll 300 as shown in FIG. 3. Although not shown in FIG. 1, the shim 104 is preferably mounted such as to fit within and be projectable from an opening or hole at an upper side of the sleeve 200 as shown in FIG. 2.

In a preferred embodiment, as shown in FIG. 1, a manually rotatable knob or turning handle 107 is mounted to the end of the shaft 103, such as to be capable of rotating the shaft 103 around its central axis of the shaft. Preferably, the second sleeve holder 106 includes a central hole through which the shaft 103 extends to the turning handle 107. As a result, a user can manually rotate the turning handle 107, causing the shaft 103 to rotate, which, thus, causes the CAM block 105 to rotate such as to cause the shim 104 to be raised and/or lowered.

In the preferred embodiments, the shim is a projection that is movably received within an opening in the sleeve and which contacts the rotating CAM block 105, and the shim 104 is configured to make sliding contact with a cam surface of the CAM block 105 while the CAM block 105 is rotated such as to impart a variable motion to the shim (e.g., being reciprocatable upwardly and downwardly). The shim is, thus, variably pressed against the interior of the core member and, thus, variably provides a rotational resistance to the drawing of paper from the roll of expandable slit sheet paper. The rotational resistance causes the slit paper to expand as it is drawn from the roll of slit sheet paper.

Thus, in the preferred embodiments, the shim 104 is a member that slides on the CAM block 105 during operation. The shim 104 can be made of a variety of materials. In some preferred embodiments, the shim is relatively rigid and has a smooth outer surface. In some examples, the shim can be a piece of wood, metal, ceramic, or plastic. In some illustrative and non-limiting embodiments, the shim has a thick middle region and tapers to a thin edge as shown. In some embodiments, the shim 104 has a curved contact surface that is configured to follow a curvature of the interior of the core. In some preferred embodiments, the shim 104 is driven between the CAM block 105 and the interior of the core upon which the paper roll is wound. In some implementations, the shim variably separates or spaces the sleeve 200 from the interior core member (not shown) when raised such as to press against the interior of the core while the surface of the shim 104 extends further above a perimeter surface of the sleeve.

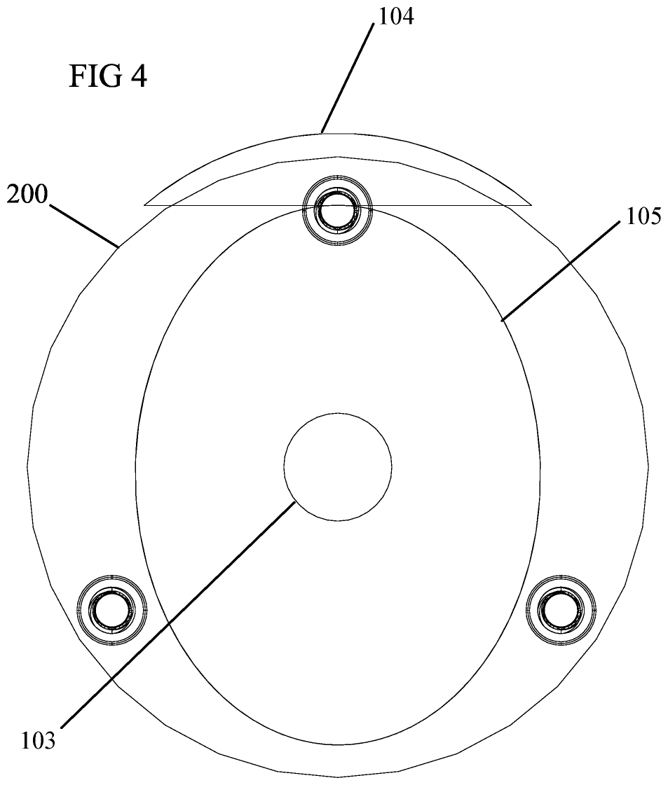

In some preferred implementations, the shim 104 operates as a wedge which fits into the space between the cam block and the interior of the core member, and is pressed by the cam block against the interior of the core member. In some preferred embodiments, the shim 104 has a curved or an arcuate upper surface and a flat or planar surface, thus, providing a bow like configuration as illustrated in FIG. 4. The curved surface preferably coincides with the curvature of the interior core member. On the other hand, the flat or planar lower surface preferably acts as a cam surface that slidingly engages with a corresponding cam surface of the cam block 105.

FIG. 2 is a perspective view of the sleeve 200 as it sits on the sleeve holders 102 and 106 (i.e., with the holder 102 shown in FIG. 1 being hidden in the view of FIG. 2). As shown in FIG. 2, the shim 104 is extendable upwardly through the hole in the sleeve 200 such as to be movably to the interior of the core that is received over the sleeve. In FIG. 2 the shim is depicted in a position raised upward above the outer perimeter of the sleeve upward through the hole in sleeve 200.

FIG. 3 is a perspective view of the paper roll/paper core 300 placed over the sleeve 200 with the sleeve extending through a paper core member at the center of the roll 300.

FIG. 4 is a side view of the friction system shown in FIG. 1 according to some illustrative embodiments. As described above, upon turning the turning handle 107, the shaft 103 is rotated which results in raising or lowering of the shim 104 due to the non-circular outer shape of the cam block 105 (e.g., elliptical outer shape of the cam block in the illustrative example shown in FIG. 4). Thus, turning handle 107 (not shown in FIG. 4) turns the shaft 103, which turns the cam block 105, which raises or lowers the shim 104 in relation to the perimeter surface of the sleeve 200. As shown in FIG. 4, the shim 104 is in a most-raised position due to the radius of the cam block 105 being a maximum at the contact point with the shim 104. In FIG. 4, the three circular elements shown approximately equidistantly around the perimeter of the sleeve 200 show bolts or other fixing elements that fix the sleeve 200 relative to the frame in some illustrative and non-limiting examples.

### Second Embodiment

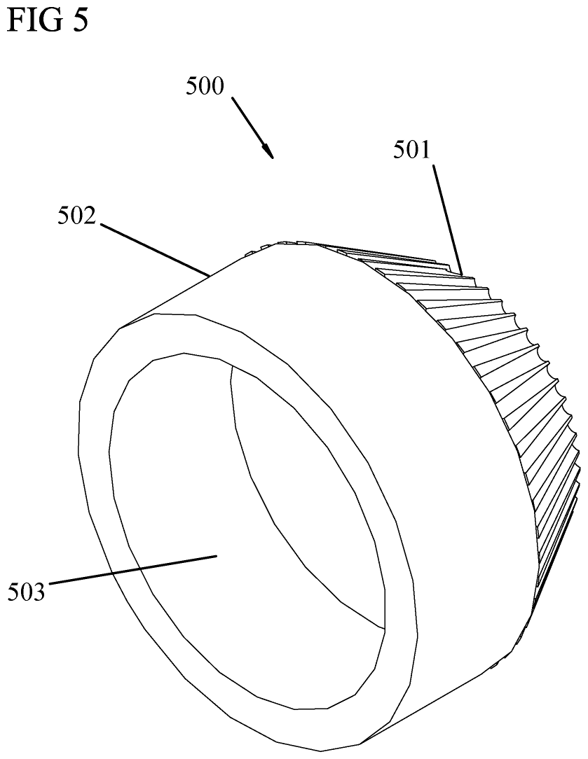

FIGS. 5 to 9 show another embodiment of the present invention.

In this second embodiment, a tensioning device is formed as best shown in FIG. 9. In the preferred implementations, as shown in the perspective view of FIG. 5, a paper core insert 500 is provided includes a radial cone 501 is configured to be pushed axially into paper core 800 (see FIG. 8).

In the illustrated embodiment, the insert 500 includes a smooth radial section 502 with open area 503 (e.g., the area 503 can be a cup-shaped circular receiving opening). In addition, the insert 500 as includes a tapered or conical portion adjacent the smooth section 502, which has a radial diameter that decreases in a direction away from the open area 503. As shown the outer surface of the tapered or conical portion preferably include a roughed frictional surface, such as, e.g., a plurality of ridges and/or grooves extending in an axial direction (e.g., generally parallel to an axis of the core). As discussed below, the roughed frictional surface helps to create a firm engagement with the paper core when inserted into an open end of the paper core.

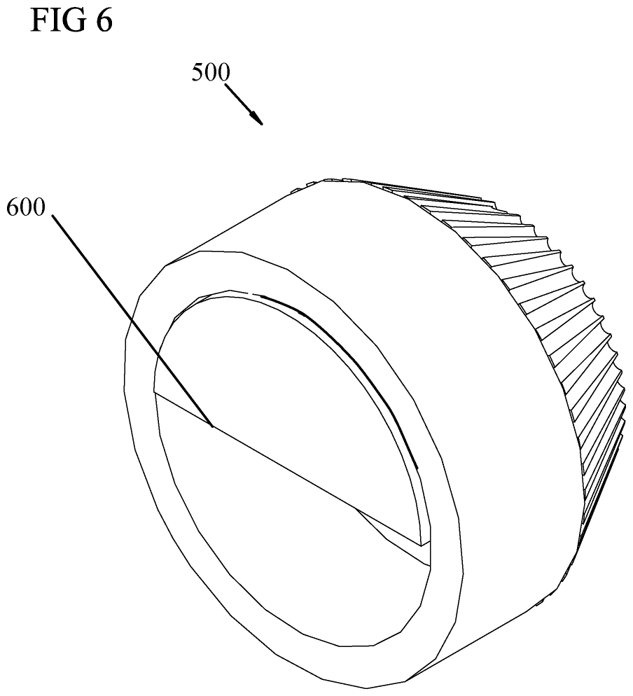

As shown in FIG. 6, the open area 503 of the insert 500 is preferably configured to receive a puck 600. As shown in FIG. 6, the paper core insert 500 preferably rests on the puck 600, such as to support the paper core insert on the dispenser.

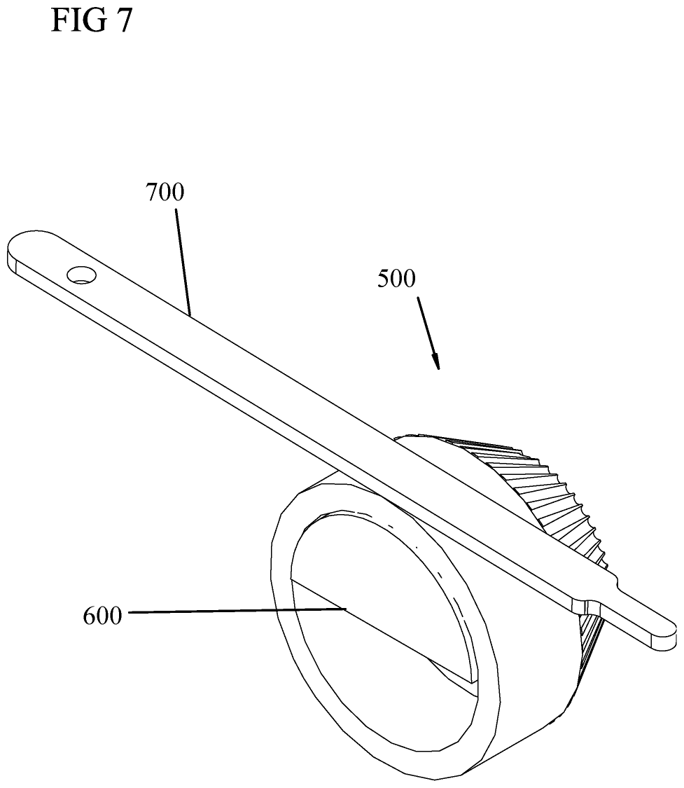

FIG. 7 is a perspective view of the paper core insert 500 resting on the puck 600, along with a tensioning bar 700 that is arranged to apply pressure to the smooth portion 502 of the paper core insert 500 and, thus, press the core insert member 500 against the puck member 600. The puck 600 is preferably mounted to a frame of the dispenser, and operates to support the paper core insert 500, which, in turn, supports an end of the core. With reference to WO2019212980A2, FIG. 1 of this latter reference illustrates a core support 102 that functions in a manner that generally corresponds to the functioning of puck 600 by supporting an end of the paper core. The disclosure of WO2019212980A2 is incorporated by reference as though recited in full. In particular, WO2019212980A2 discloses at ¶¶ [0036] and [0037] that: “FIG. 1 is a perspective view of the entire tensioning assembly and dispensing structure 100 without the roll of expandable slit paper. The tensioning assembly is mounted on side fixture 101. The tensioning assembly includes a tension member 103, thumbscrew 104, and spring 105. The tension member 103 can be in the form of a rod or bar. The tensioning assembly applies tension, that is, rotational resistance, to the paper core, 204 (shown in FIG. 5) by pressing the core end region 203 (as shown in FIGS. 3 and 4) against core support 102 that is in the form of a support bar that is fixed, that is, attached to fixture 101. The side fixture 106 provides support for the interior core end region Tensioning assemblies 103, 104 and 105 of FIG. 1 are of the same basic design as disclosed in U.S. nonprovisional patent application Ser. No. 15/428,144 (Publication No. 2018-0222665). On the opposite side from side fixture 101, the bottom of the yoke area 107 supports the paper core end region 201, as shown in FIG. 2. Thus, the paper core end region 201 rests in the yoke area 107 of the side fixture 106. After the paper is loaded, the paper core end region 201 can be held in place by a core positioning member 108 that holds back the paper roll 201 of FIG. 2, thus inhibiting the end core region 201 from sliding on the core support member 102.”

In the perspective view of FIG. 8, in an operation state, the paper core insert 500 is fully inserted into an end of the paper core 800. In that condition, the paper core 800 frictionally engages with the outer surface of the tapered or conical portion (i.e., frictionally engaging the roughed frictional surface (e.g., the plurality of ridges and/or grooves extending in an axial direction). The tensioning device in its preferred embodiment is to be made from aluminum. However, in other embodiments, the tensioning device can be made with wood, steel and/or other metal components. In the preferred embodiments, the tensioning device, including the tension rod, spring and thumbscrew, are of a similar design as found in publication, US 2018/0222665, the disclosure of which is incorporated by reference herein, as though recited in full. In this new embodiment shown in FIGS. 5-9, a new design is provided in which the paper ore insert 500 serves as a short bar on the tensioning side that supports the core 800, while a yoke supports the core on an opposite side as shown.

Among other things, in some embodiments, this combination enables the roll of paper to be loaded without the need for removing the tensioning rod, thumbscrew, and spring. In particular, 2018/0222665 discloses at ¶ [0133] that: “FIG. 6 is the single expansion apparatus made up of two yokes 602 and preferably at least three cross members 601. Paper core 608 sits in the yoke 602 and holds the paper roll 603 that is wound around it. A threaded insert 607 receives thumb screw 604 first through the spring 605 and then through roll holder 606 and into the metal threaded insert 607 to enable the roll holder to apply downward pressure to the paper core 608.”

Additionally, the system shown in FIGS. 5-9 provide an advantage in that the friction of the tensioning device can be applied between the tensioning arm and the smooth surface 502 of the insert 500. In that manner, the materials of the tensioning bar and insert 500 can be specially selected for, e.g., frictional qualities and can be made of a refined and consistent shape. In contrast, when tensioning involves application of pressure against a paper core and/or a paper roll on the paper core, the irregular nature of the paper core or paper roll can lead to less controlled tensioning. Moreover, as the smooth surface 502 and the tensioning bar are part of the overall device, the tensioning is consistent and does not depend on characteristics of the paper core or paper roll.

As shown in the perspective view in FIG. 9, when assembled, the paper roll 900 surrounds the paper core 800, which is pressedly engaged to the insert 500. As a result, the insert 500 and the paper core 800 and paper roll 900, thus, rotate in unison around the axis of the paper core 800.

### Third Embodiment

FIG. 10 is a perspective view of the nip roller dispensing system 1000 where slit sheet roll 1000 sits on a rod 1003 in frame 1002 and is kept centered with locking spacers 1004. The expanded slit sheet 1009 is fed through the pair of rubberized rollers 1006 and exits expanded. The spring loaded thumb screws 1010 control of the expansion of the slit sheet material by pressing on rubberized rollers 1006 and can be adjusted to increase tension as shown with arrow 1008.

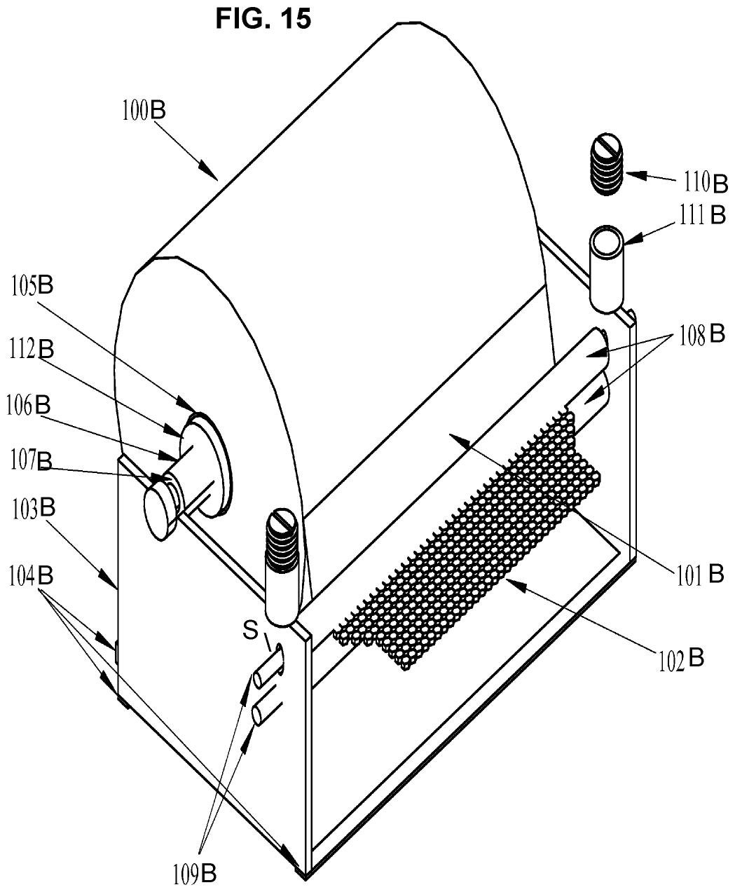

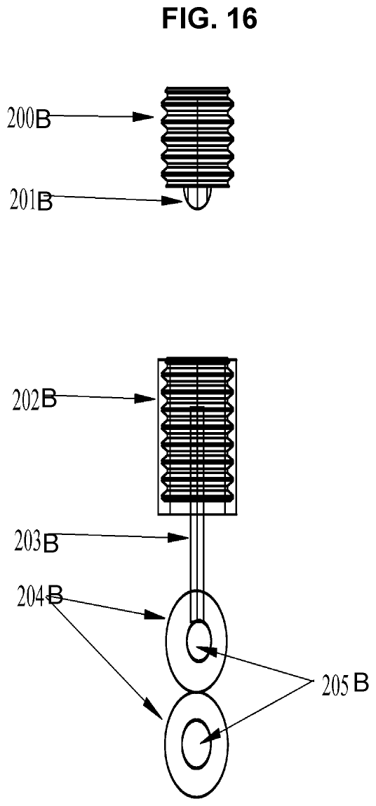

Additionally, another embodiment that is similar to that shown in FIG. 10 is shown in FIGS. 15-16.

With reference to FIGS. 15-16, the manual expander in this embodiment is made up of three major parts. The first being the frame to hold the roll of expanded slit sheet material and pressure roller fixture that feed and allows the stretching action of the material. The second part is the paper holding that enable the roll to turn freely as required. The third part is the pressure roller system that allows the paper to feed but simultaneously apply a back pressure to enable the stretching process of the expanded slit sheet material.

The framework is made up of two side frames and steel slats that are bolted in place to connect the two side frames together.

Handling the paper roll is quite simple wherein the paper is supported by a paper tube and two plastic centering cores that arrive with each expanded slit sheet paper roll. A steel rod is placed through the paper roll. On the left end of the rod is a permanent fixture that centers the paper so that the paper is centered on the machine. The second removable rod slides into place to hold the paper from sliding rightward. The rod itself is self-positioning by using a slot that is machined into both side frames which mates with a reduced diameter slot on the rod itself. These two create a locking mechanism that does not allow lateral movement of the rod.

The paper is then feed through the pressure rollers and awaits the use of an operator's hands to pull the paper through. A simple method of loading the paper is to guide the paper between the rollers with one hand and then with the other roll the upper pressure roller towards the back of the machine. This will force the paper through the rollers.

The pressure roller system is made up of a number of parts to enable a constant and even pressure regardless of the size of the paper roll. As it unwinds the paper roll gets lighter but, this will not affect the ability of the expander to maintain consistent stretching Properties. The first two parts are the horizontally oriented and parallel aluminum rolls that are held in place by a rod, or journal, that are at each end of the rubber-aluminum roll. Each rod is then affixed to the side frame through a brass or plastic bushing to inhibit side to side movement with the use of set screws. Each aluminum roller has a rubber to enhance the gripping action required to feed the paper. At this point, the rollers are able to turn freely.

To create the friction portion of the manual expander, spring-type vertically oriented set screw presses on both sides of the roller down on the bushing of the top roller system. By applying more or less pressure the set screws create the perfect pressure that allows the paper to feed and stretch but, not rip.

The set screw has a small protrusion at the bottom end that is spring loaded so that the pressure increases as you screw in the set screw. The ball bearing presses on a rod that in turn applies pressure to the bushing. The set screw itself is screwed into a machined cup that is attached to the frame. This cup is for the extra width of this type of spring operated set screw and the associated threads that enable the buildup of the pressure as the set screws are turned clockwise. Preferably, both set screws place the same amount of pressure on both sides of the roller or the paper can tend to lead to the side that has the greater pressure.

To set the pressure rollers to the right pressure, the user would guide the paper through the rollers and attempt to stretch the paper. If the paper does not stretch then a clockwise turn of both setscrews will add pressure. If the paper tears then the setscrews should be turned counterclockwise.

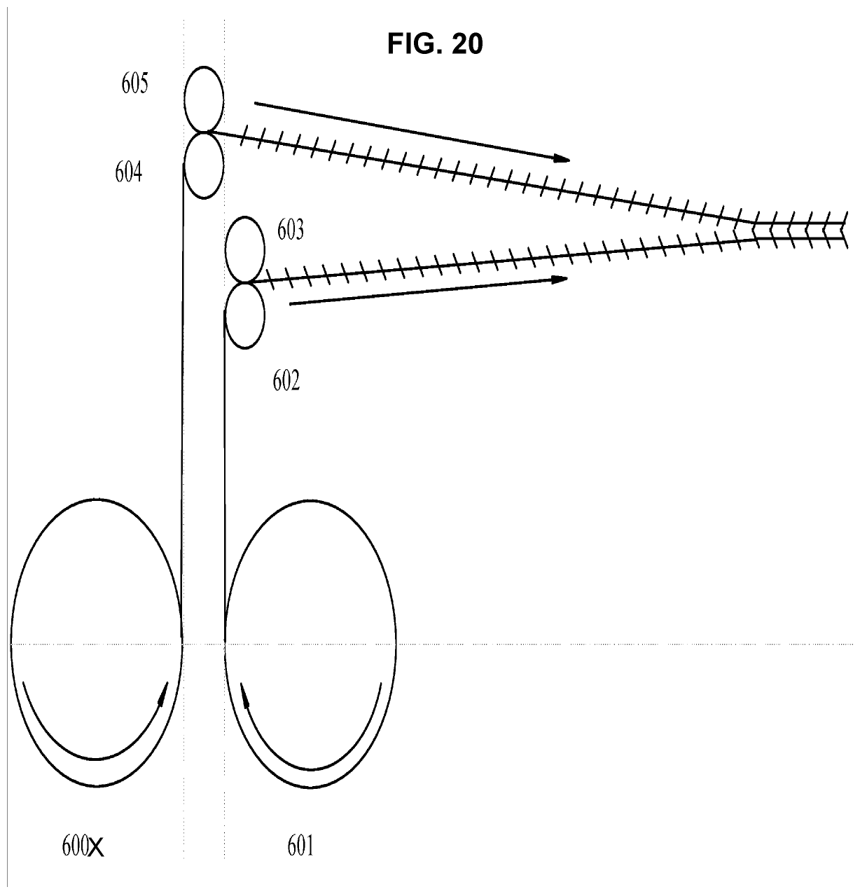

In the embodiment shown in FIGS. 15-16, a single roll of expandable slit sheet paper is employed, and, therefore, a single layer of expanded slit sheet material exits the expander. However, in some embodiments, plural layers can be conveyed together. For example, in some embodiments, plural layers of expandable slit sheet paper can be included within the expander. For example, FIG. 20 schematically shows a plurality of layers of expandable slit sheet paper being expanded concurrently. The embodiment shown in FIGS. 15-16 can be similarly adapted for plural layers being expanded together in some embodiments.

In some preferred embodiments, a mechanism is provided to inhibit nesting between adjacent layers. For example, in some embodiments, the expandable slit sheet paper can be configured to present a unique expansion pattern; for example, providing a non-uniform or chaotic pattern as described below. As another example, an interleaf (e.g., another layer of non-expandable paper) can be provided to inhibit nesting.

With respect to embodiments that employ a non-uniform pattern, by way of example, such a non-uniform layer can help the sheet material to package an item correctly. In some embodiments, a non-uniform layer of material is one that the hexagonal cells open in a random fashion at least 50% of the time to provide the inability for the cells to nest as they are wound against successive expanded layers around an object being packaged.

The present inventor has found that the deliberate desire for a chaotic pattern of switchbacks of at least 50% of the total number of cells create a non-nesting effect between the adjacent layers that buildup around an item to be wrapped by the expanded slit sheet material. These random changes are created by switchbacks due to the use of thinner paper that is less effected by the wedge effect of the tooling used to cut the paper as described in the prior art so referenced within this filing.

With respect to embodiments that employ an interleaf material, the prior art teaching of Ser. No. 14/480,319 desires a uniformity of cells with the deliberate use of a double layer feeding system that requires each layer to face in opposition to the layer underneath. In this case the deliberate use of uniformity inhibits nesting of the product as prior art teaches to cure this through the use of an interleaf that separates the cells as shown in filing 5,688,578.

In testing an illustrative example of this new structure against the uniformly but opposing double layer expanded slit sheet system a 400 foot roll of single layer cells created a diameter of 25″ while 200′ of the double layer system produced 22″. Each roll had the exact amount of paper in length and weight. Two layers of double equals 400 feet of continuously feed single layer chaotic product. The rolls at the end of the testing had the same square footage of material used. They varied in paper weight since the paper with the majority of virgin paper was thinner and therefore weight less per square foot as the recycled paper. The virgin paper as per the TAPPI standard weighed 50 pounds per 3000 square feet of material while the recycled paper weighed 60 pounds per 3000 square feet of material prior to expansion.

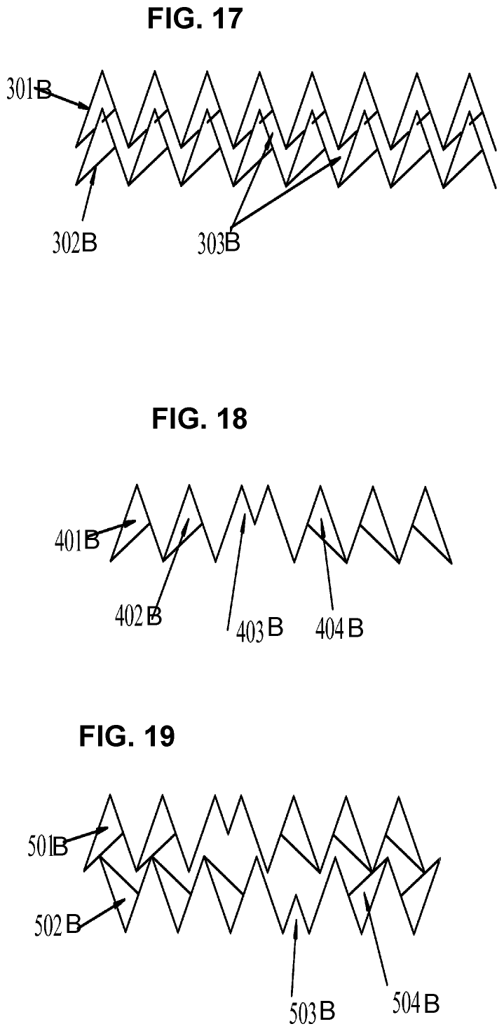

In some embodiments, the present invention provides a random chaotic pattern that produces the same non-nesting effect as the double layer in a similar way but, with a chaotic looking patter as shown schematically in, for example, FIGS. 17, 18 and 19.

In some embodiments, a double layer manual expander, as shown in FIG. 20, can be provided. In some embodiments, the expander would include two roll stands and two pressure roller systems as shown in FIG. 16. In some embodiments, the rolls of expandable slit sheet paper would be either thicker recycled paper and mounted in opposing cell patterns for uniform non-nesting layers or two virgin thinner paper layers that would open chaotically creating a non-nesting layers.

With reference to FIG. 15, FIG. 15 is a perspective view of the expander where 100B is the un-stretched slit sheet material sitting on paper core 105B. In the illustrative example, 105B is supported by plastic core 112B that in turn sits on steel rod 106B. 106B has a machined slot 107 that enables the rod to fit into a semi-circle slot with the exact radial dimensions on the side frame 103B. The paper 101B is guided from the paper roll 100B through pressure rolls 108B and become the expanded slit paper material 102B. In the illustrated example, the tensioning device of the rollers includes journals 109B, set screw cup 111B, and push rod 203B, shown in greater detail in FIG. 16. In the illustrated embodiment, side frame cross supports 104B hold the main side frame fixture 103B in position and secure the assembly.

FIG. 16 shows further details of the assembly of the pressure system that creates the tension for the rollers, wherein 205B are the journals to each roller not shown for simplicity. Bushings 204B trap the journals into position within the side frame also not shown for simplicity. Push rod 203B applies pressure to the top bushing 204B by the clockwise screwing action of set screw 200B with spring bearing 201B by a vertically coiled spring within the assembly of set screw 200B not shown. The set screw is placed into set screw cup 202B and turned clockwise to apply a downward force to push rod 203B which in turn applies the same force to bushing 204B and journals 205B. Since 205B is attached to the rollers 108B, the entire system receives pressure a braking force that inhibits the paper from exiting freely.

Additionally, in some embodiments, the upper journal 109B can be vertically movable within the slot S.

With respect to FIG. 17, FIG. 17 shows a simplified schematic side view of an expanded slit paper system that is nesting and is not optimally being used. 301B is the leg of the angled cell. One can tell the cell is facing right by line 302B that is a mere rendition to describe how the cell is facing. In reality, it is difficult to tell which way the cell is facing from a pure side view of the expanded slit sheet material. In this case, spaces 303B show not really the nesting that is occurring but the nesting that will occur just prior to nesting or the nesting process. Since the actual nesting that would occur in this instance would cause the upper and lower layers, as shown, to actually touch and therefore would look like only one layer from this viewpoint. As described in the background art this nesting is not an optimal use of the expanded slit sheet material.

FIG. 18 is a side view of expanded slit sheet material that has one switchback 403B as shown. The leg 401B is facing right as depicted by the rendition shadow leg of 402B. When switchback 403B occurs a halving of the cell is created at the midline of the cell leg and causes a distortion of the paper at the point of the switchback. The cells then face to the left as depicted by 404B.

FIG. 19 shows a net result of two layers that this chaotic effect has on the expanded slit sheet paper interaction according to some embodiments. Where right facing 501B interact with left facing cell 502B underneath, etc., as one observes the cells from left to right. The leftward facing cells interact with the lower and opposing rightward facing cells thereby inhibiting cell wall nesting. So, in this instance, a chaotic switchback cell structure creates the non-nesting effect of the uniformly opposed cell structure of the prior art. It should be understood that this concept is not as perfect as the uniformly opposing cell structure but, surprisingly the testing done proves otherwise.

FIG. 20 depicts a simplified side view of a double layer system that shows unexpanded slit sheet rolls 600X and 601 fed up to pressure rollers pairs 605-604 and 603-602 that would have the set screw system shown in FIG. 16. FIG. 20 shows, by way of example, a uniform opposing cell approach leading to a combining by hands pulling in the direction of the arrows.

In some alternative embodiments, while the above examples of the third embodiment apply resistance by pressure to the paper of the paper roll (i.e., along the face surface of the paper, rather than the thin edge surface of the paper) after removal from the paper roll as shown in FIG. 10 and in FIGS. 15-16, in alternative embodiments, the device can be configured to apply resistance by pressure to the face surface of the paper of the paper roll before removal from the paper roll. For example, in some embodiments, one or more rubberized rollers 1006 can be mounted proximate the paper roll, such as to move against the periphery of the paper roll such as to apply pressure to the paper roll such as to impart resistance. In some embodiments, the rubberized rollers can be moved via a similar mechanism to that shown in FIG. 10 or in FIGS. 15-16, or can be mounted via a cantilevered arm such as to reciprocate towards the paper roll. In this modification of the third embodiment, rather than pressurizing the paper between a paper of rubberized rolls that contact opposite side faces of the paper after exiting the roll, the at least one rubberized roll pressurizes the paper on the roll by pressing the outer periphery of the paper roll, such that the paper roll is pressurized between the supporting core and the at least one rubberized roll.

Although a rubberized roll is described, it should be appreciated that other embodiments could include other roll materials, such as, e.g., plastics, metals, and/or other suitable materials. For example, in some embodiments, the rollers (e.g., rollers 1006 in FIG. 10 or rollers 108A in FIGS. 15-16) can include friction members, such as, e.g., hooks and/or other friction members (see, e.g., illustrative examples discussed below).

In some embodiments, the embodiments of FIG. 10 and the embodiments of FIGS. 15-16 can be modified to employ an S curve manner of dispensing as taught in the present inventor's co-pending application Ser. No. 16/749,875, filed Jan. 22, 2020, the entire disclosure of which is incorporated herein by reference as though recited herein in full. For example, the expandable slit sheet paper can be dispensed via the pair of rollers of the embodiments of FIG. 10 and the pair of rollers of the embodiments of FIGS. 15-16 in an S curve format, such that the expandable slit sheet paper extends around a periphery of one of the rollers prior to passing between the pair of rollers to form an S curve configuration.

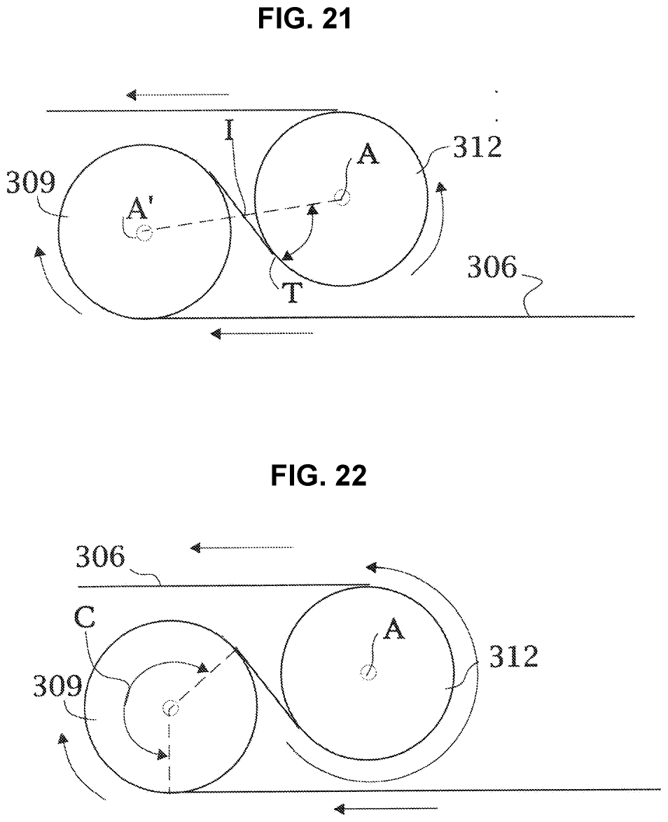

Towards this end, some embodiments of employing an S curve manner of dispensing are shown in, e.g., FIGS. 21-25. In FIGS. 21 and 22, the S shaped path that the slit paper takes between the rollers 309 and 312 can be described from a variety of perspectives. Here, it should be appreciated that in some embodiments, the rollers 309 and 312 can replace the rollers 1006 shown in FIG. 10 and rollers 108B shown in FIG. 15.

Looking from the perspective of angles formed by the axis of rollers 309 and 312, the intersection of the path of the slit paper with a line between the axis of each roller, and the tangent point at which the paper leaves a roller, is an acute angle. The relative positions of the two rollers and their proximity has a bearing on the acute angle that is formed. For example, the closer the proximity of the two rollers, the greater the acute angle.

Looking further to FIG. 21, the line between the axis A of roller 312 and the axis A′ of roller 309 intersects with the slit paper at point I. The angle (<) A-I-T, where T is the tangent point of contact between the paper and the circumference of the roller 312 is an acute angle. In the expansion system of FIG. 21, the slit paper tangentially contacts hook roller 309, interacts with the hook components of the hook roller 309, and is delivered tangentially to the point of tangent contact with hook roller 312. It should be noted that while contact with a roller is at a tangent point, the hooks of a hook roller can cause the slit paper to separate from the hooks at a point slightly beyond the point of tangency, depending upon the speed at which the paper is traveling and the tension on the slit paper. Accordingly, the term “tangent point” as employed herein, is inclusive of the slight deviation from a tangent.

With reference to FIG. 22, the slit paper 306 wraps around each of the rollers 309 and 312 following an S shaped path as indicated by the arrows shown in FIG. 21 and FIG. 22. The tendency of the expanded slit sheet to slip backward, which can cause the sheet to revert to becoming partly or fully unstretched and, thus, unexpanded, is in an inverse ratio to the degree of contact between the slit paper 306 and the hook surface of the rollers 309 and 312. Thus, where the contact region between the slit paper 306 and the hooks of the rollers is up to about ⅔ (around 235°) backward slip prevention is optimized. It is noted that a contact arc that is preferably less than 270 degrees is required for ease of machinery design and construction, and, accordingly, a lesser arcuate contact region is provided (e.g., lesser than 270 degrees).

The contact region advantageously is greater than ¼ of the circumference (i.e., 90°), and preferably greater than ½ of the circumference (i.e., 180°), and, most preferably, up to about 250°, which produces contact of the paper with about 70% of the hook surface of the rollers.

Furthermore, contact of the slit sheet with the hooks of each roller is preferably advantageously in the range from 90° to less than 2700. More preferably, contact of the slit sheet with the hooks of each roller is in the range from 180° to 235° which produces contact of the paper in the range from about 50% to 65% of the hook surface of the rollers. As shown in in the embodiment of FIG. 22, the arc C shows that the slit paper contacts more than 50% of the circumference of the hook roller 309. Notably, although the degree of contact of the paper with the hook surfaces of the rollers 309 and 312 can be different from one another, advantageously, the degree of contact can be optimized for each roller in the preferred embodiments.

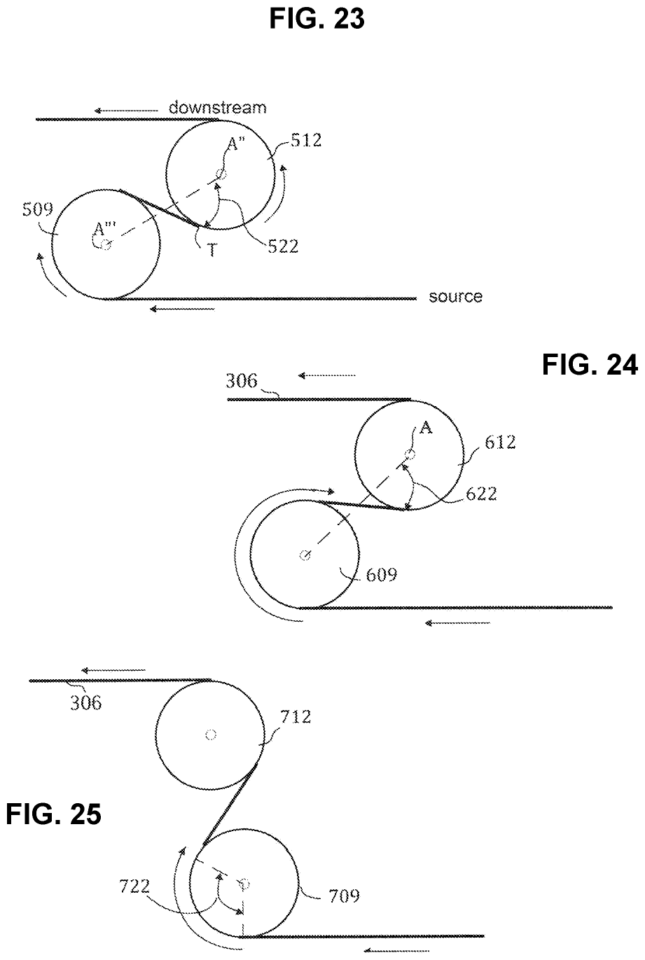

FIGS. 23, 24, and 25 show illustrative changes of degree of contact between the slit paper and the roller based upon the relative positions of the two hook rollers 509 and 512. As shown in FIG. 23, a line between axis A″ and axis A′″ intersects with the expanded paper flowing from roller 509 to roller 512 to form an acute angle 522.

In FIG. 24, the acute angle 622 is narrower than the acute angle 522 of FIG. 5. As shown in FIGS. 23 and 24, as the relative positions of rollers 509 and 512 are changed to the relative positions of rollers 609 and 612, the degree of arcuate contact between the slit paper 306 and the rollers decreases.

FIG. 25 shows an alternate “S” path flow pattern in which the slit paper 306 contacts the roller 709 along an arc 722 that is smaller than the arcuate contact regions illustrated in FIG. 23 and FIG. 24. As shown in FIGS. 24 and 25, as the relative positions of rollers 609 and 612 are changed to the relative positions of rollers 709 and 712, the degree of arcuate contact between the slit paper 306 and the rollers become further decreased.

As discussed above, although in some implementations of the embodiments shown in FIGS. 21-25 hook rollers are employed, in various embodiments, the rollers can include other materials, such as, e.g., a rubberized roll and/or other roll materials, such as, e.g., plastics, metals, and/or other suitable materials.

### Additional Variations and Embodiments

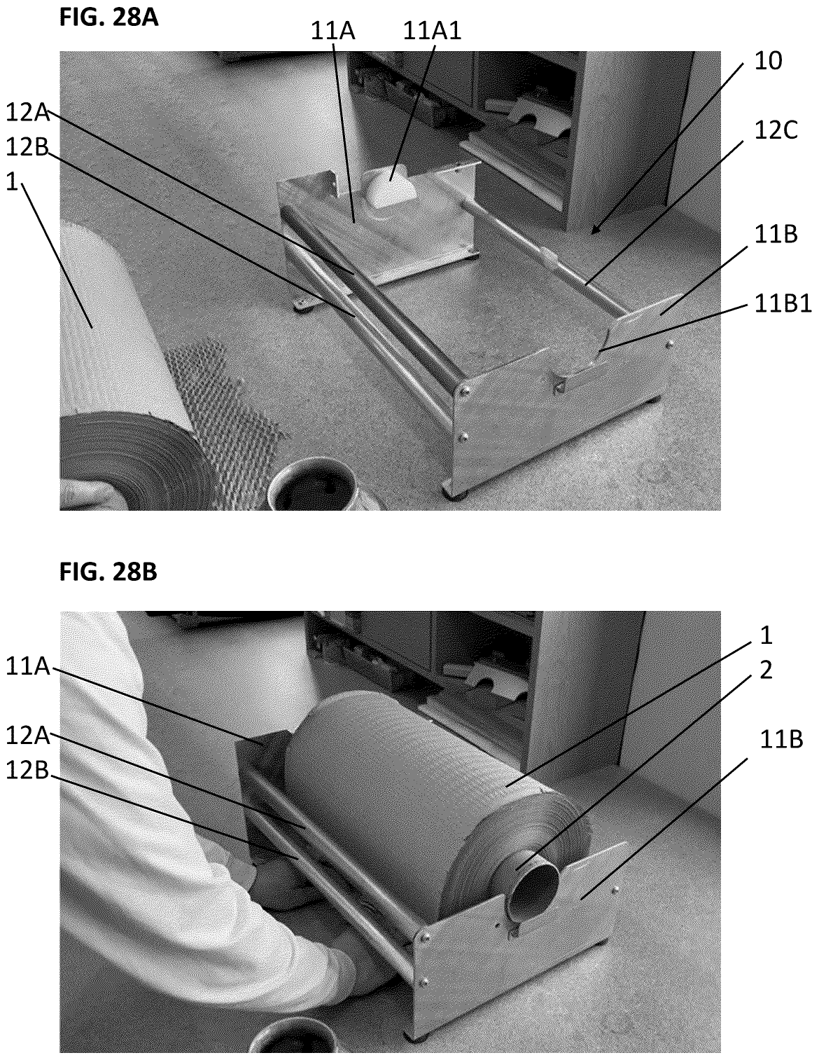

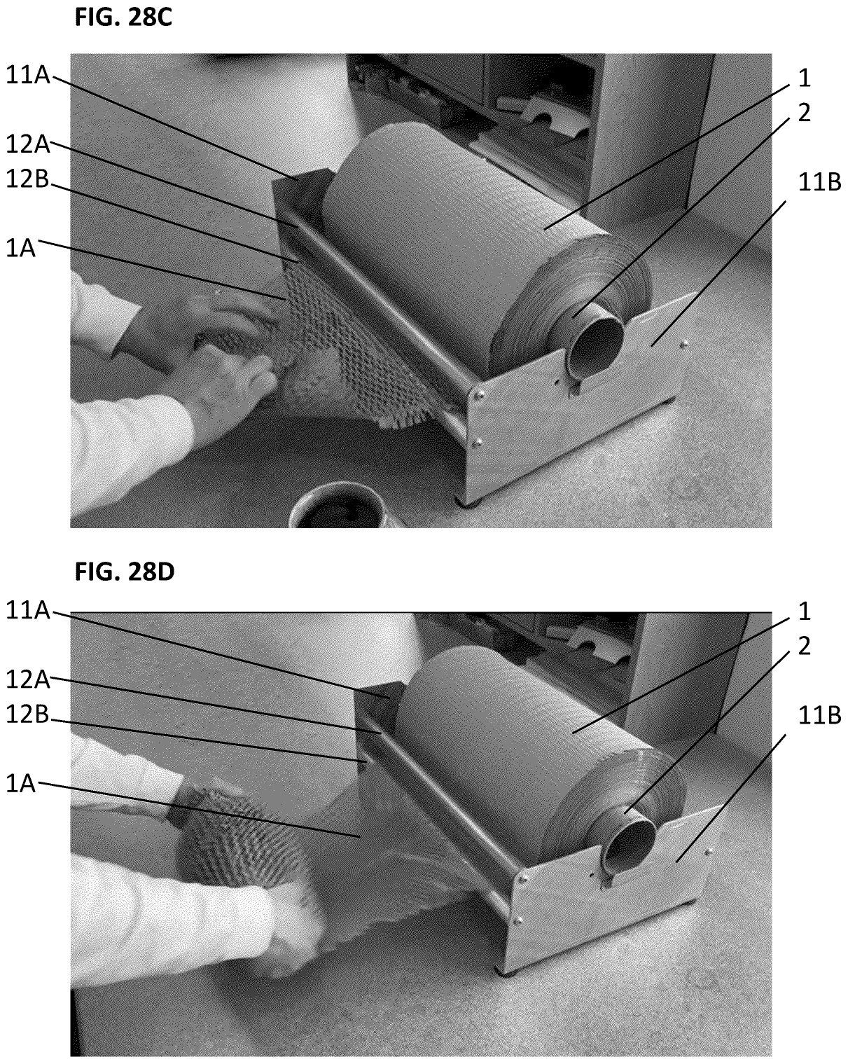

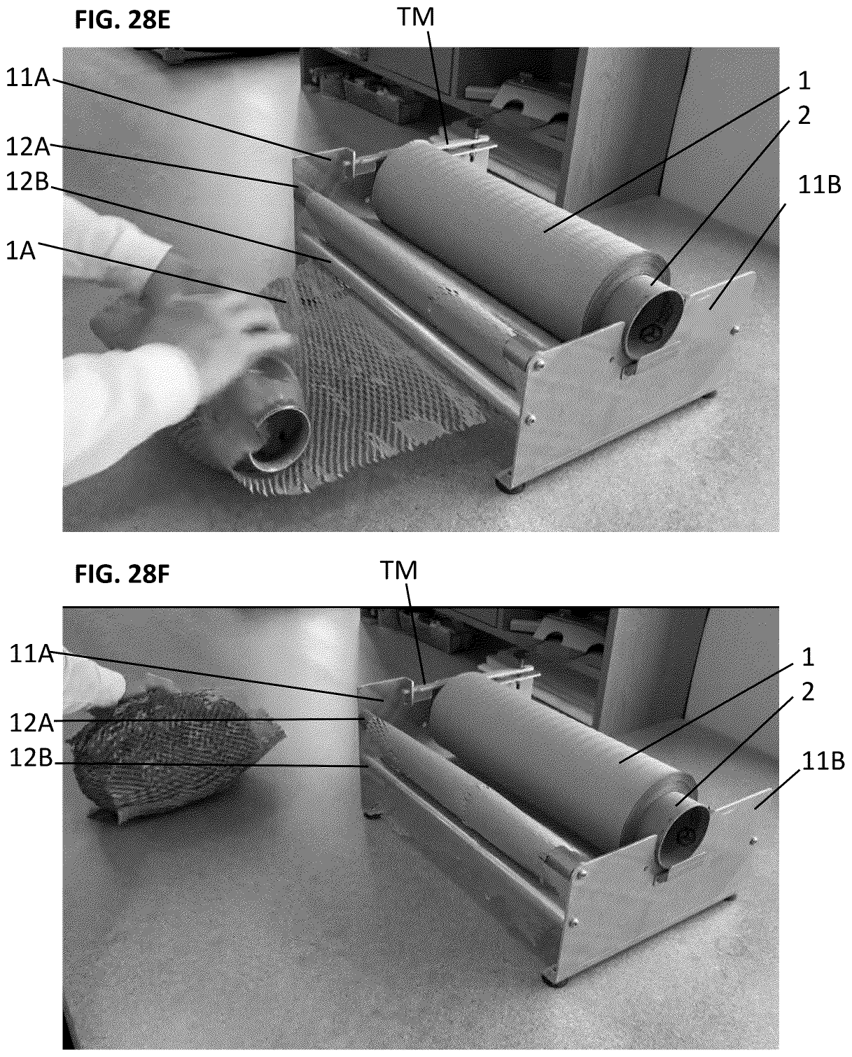

FIGS. 28A to 34 show, among other things, additional embodiments employing an S curve manner of dispensing similar to that described above in relation to FIGS. 21 to 25. Among other things, the embodiments shown in FIGS. 28A to 34 show novel systems and methods providing adaptability of the tension applied to the expandable slit sheet paper with a dispenser employing a pair of cross-bars to form, e.g., an S curve configuration of the expandable slit sheet paper extending around such pair of cross-bars.

First, FIGS. 28A to 28F, discussed further below, show a first further embodiment employing a novel system and method in which the path followed by the expandable slit sheet paper around the pair of cross-bars is altered over time during dispensing such as to vary the tension applied during dispensing by manually altering the path of the expandable slit sheet paper around the pair of cross-bars.

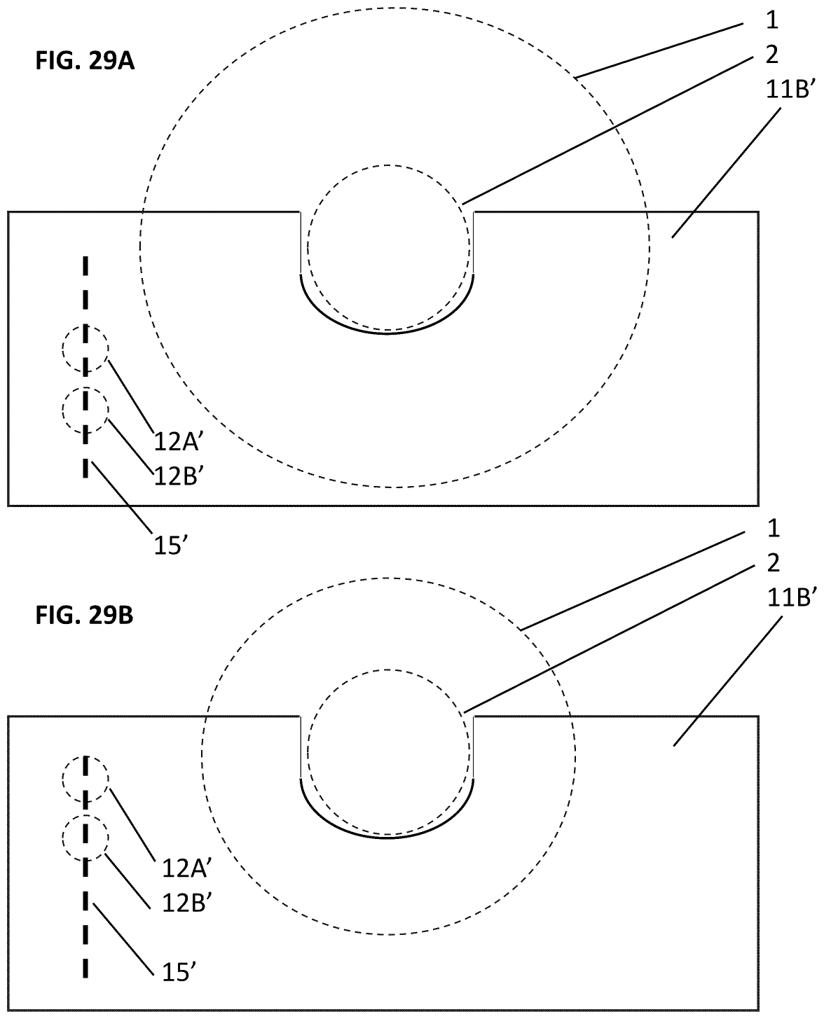

Second, FIGS. 29A to 29B and FIGS. 30A to 32B, discussed further below, show further embodiments employing novel systems and methods in which the path followed by the expandable slit sheet paper around the pair of cross-bars is altered over time during dispensing such as to vary the tension applied during dispensing by adjusting the positions of the pair of cross-bars upon the dispenser.

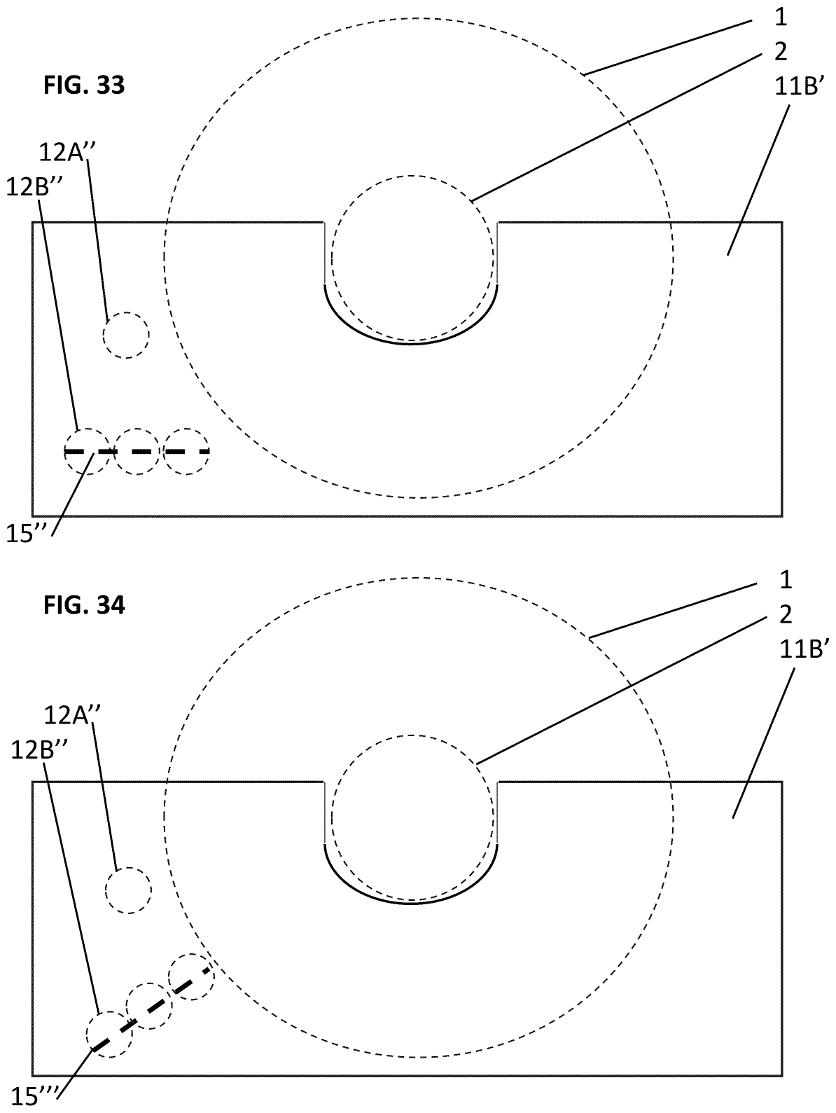

Third, FIGS. 33 and 34, discussed further below, show further embodiments employing novel systems and methods in which the path followed by the expandable slit sheet paper around the pair of cross-bars is altered over time during dispensing such as to vary the tension applied during dispensing by adjusting the position of one of the cross-bars within the pair of cross-bars upon the dispenser.

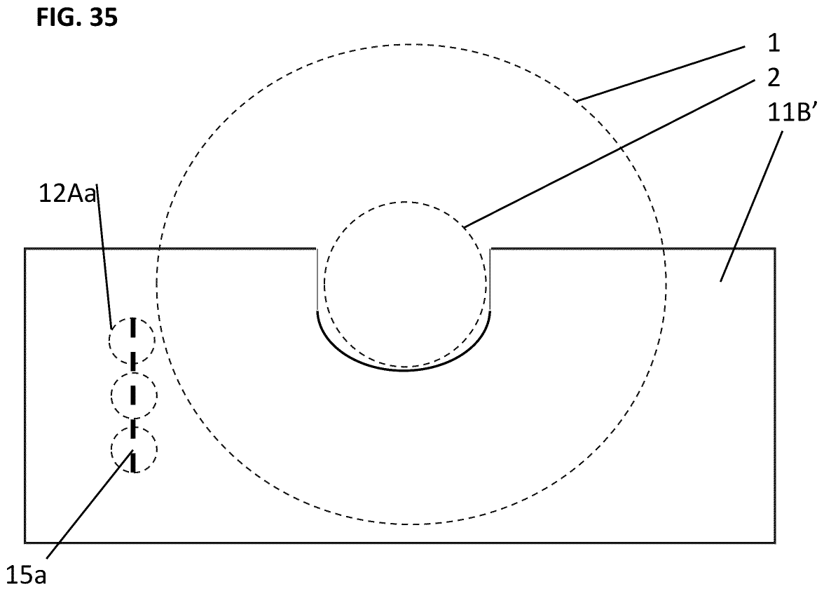

Fourth, FIGS. 35 to 39, discussed further below, show further embodiments employing novel systems and methods in which the path followed by the expandable slit sheet paper around a single cross-bar is altered over time during dispensing such as to vary the tension applied during dispensing by adjusting the position of the single cross-bar upon the dispenser.

With reference to the embodiment shown in FIGS. 28A to 28F, this embodiment shown in FIGS. 28A to 28F involves a dispenser 10 for dispensing expandable slit sheet paper, which includes a frame having two sidewalls 11A and 11B that are configured to support a roll 1 of expandable slit sheet paper wound around a core member 2 by placing a first end of the core member 2 upon a support 11A1 on a first of the sidewalls, sidewall 11A, and placing a second end of the core member 2 upon a support 11B1 on a second of the sidewalls, sidewall 11B. In the illustrated example, the support 11A1 includes a puck, which can be configured and operate similarly to the puck 600 shown and described above in relation to FIG. 6, and, in the illustrated example, the support 11B1 includes a yoke, which can be configured and operate similarly to the yoke shown and described above in relation to FIG. 8. In other embodiments, the supports 11A1 and 11B1 can both include yokes, or, in some alternative embodiments, can both include pucks or other support members that fit within the ends of the core member 2. In the event that both supports 11A1 and 11B1 include pucks or other support members that fit within the ends of the core member, one or both of such pucks or other support members are preferably movably mounted upon the respective sidewalls 11A, 11B such as to be movable into and out of the ends of the core member 2 to support the core member 2 and the roll 1 wound thereon upon the dispenser 10 or to remove the core member 2 and the roll 1 wound thereon from the dispenser 10.

As shown in FIG. 28A, in the illustrative embodiment, the dispenser 10 includes a plurality of bars extending between the sidewalls 11A and 11B. In the illustrated embodiment, the plurality of bars include bars 12A and 12B proximate a first side of the dispenser on a first side of the roll 1 and core member 2, and a bar 12C proximate a second side of the dispenser on a second side of the roll 1 and core member 2. Although the illustrated embodiment includes two bars 12A and 12B along the first side of the dispenser, in other embodiments three or more bars can be positioned along the first side of the dispenser. Additionally, although the illustrated embodiment includes one bar 12C along the second of the dispenser, in other embodiments two or more bars can be positioned along the second side of the dispenser. In the illustrated embodiment, the bar 12C is provided for structural purposes to connect the sidewalls 11A and 11B. Accordingly, the structural purposes of the bar 12C differs from that of the two bars 12A and 12B, as discussed further below.

As shown in FIGS. 28A to 28F, in some preferred embodiments, the sidewalls 11A and 11B are made with a metal, such as, e.g., aluminum, stainless steel and/or other suitable metals. In other embodiments, the sidewalls 11A and 11B can be made with other materials, such as, e.g., wood, ceramic, plastic and/or other suitable materials.

As also shown in FIGS. 28A to 28F, in some preferred embodiments, the cross bars 12A, 12B and/or 12C are made with a metal, such as, e.g., aluminum, stainless steel or other suitable metal. In other embodiments, the cross bars 12A, 12B and/or 12C can be made with other materials, such as, e.g., wood, ceramic, plastic and/or other suitable materials.

In some preferred embodiments, the cross bars 12A, 12B and/or 12C are fixedly attached to the sidewalls 11A and 11B, such as, e.g., employing bolts that extend through the respective sidewalls 11A and 11B and threadedly engage with threads within respective ends of the cross bars 12A, 12B and/or 12C.

In some embodiments, the cross bars 12A and/or 12B are adapted to adjust the friction applied to expandable slit sheet paper as the expandable slit sheet paper is manually pulled across peripheral surfaces of the bars 12A and/or 12B. For example, in some embodiments, a peripheral surface of each of the cross bars 12A and/or 12B is roughened, such as, e.g., having an irregular surface (e.g., non-smooth surface) that imparts friction as the expandable slit sheet paper is pulled along the peripheral surface of the cross bars 12A and/or 12B. As another example, in some embodiments, a peripheral surface of each of the cross bars 12A and/or 12B can include a surface treatment or a surface material that increases friction (such as, e.g., a rubber surface member, a surface member having a multitude of friction elements, such as, e.g., hooks or other engaging elements), etc.

In preferred embodiments, the cross bars 12A and 12B impart frictional resistance to expandable slit sheet paper dispensed from the dispenser 10 by having the expandable slit sheet paper follow a path around the cross bars in which contact with the peripheral surface(s) of the cross bars 12A and/or 12B imparts resistance to the expandable slit sheet paper, whereby upon manual pulling of the distal end of the expandable slit sheet paper, the expandable slit sheet paper downstream of the region subject to such resistance from the cross bars 12A and/or 12B is expanded to create expanded open cells due to the slit pattern in the expandable slit sheet paper.

As with the S-curve embodiments described above with respect to, e.g., FIGS. 21 to 25, the frictional resistance applied by the cross bars 12A and/or 12B, thus, depends on the regions of contact between the cross bars 12A and/or 12B and the expandable slit sheet paper. For example, in various embodiments, the frictional resistance corresponds to the length of the region(s) of contact or arc(s) of contact between the peripheral surfaces of the cross bars 12A and/or 12B in a similar manner to that of the arc C shown in FIG. 22 and the arc 722 shown in FIG. 25.

In some preferred embodiments, the cross bars 12A and/or 12B have curved peripheral surfaces that contact the expandable slit sheet paper, and, preferably, have a circular or a generally circular circumference.

In some preferred embodiments, the cross bars 12A and/or 12B are non-rotatably mounted on the sidewalls 11A and/or 11B. In some alternative embodiments, the cross bars 12A and/or 12B are rotatably mounted on the sidewalls 11A and/or 11B. When the cross bars 12A and/or 12B are rotatably mounted on the sidewalls 11A and/or 11B, rotation of the cross bars 12A and/or 12B is preferably inhibited (such as, e.g., via a friction applying mechanism) such as to facilitate application of frictional resistance to the surface of the expandable slit sheet paper extending around the peripheral surface of the cross bars 12A and/or 12B upon manual pulling of the expandable slit sheet paper.

In some embodiments, the dispenser 10 shown in FIGS. 28A to 28F is used to implement a novel method for expansion of expandable slit sheet paper in which the path followed by the expandable slit sheet paper 1 around the pair of bars 12A and 12B is altered over time during dispensing such as to vary the tension applied during dispensing by manually altering the path of the expandable slit sheet paper around the pair of bars 12A and 12B.

According to some embodiments, a novel method is employed in which a roll 1 of expandable slit sheet paper wound around a core member 2 is placed upon the dispenser 10 as shown in FIG. 28B. In this position, a user manually grasps a distal end of the paper wound around the core member as also shown in FIG. 28B.

Then, as shown in FIG. 28C, the user initially directs the distal end of the paper over the lower bar 12B. In this manner, when the user pulls the distal end of the expandable paper, friction imparted against the expandable paper as the paper is manually pulled across the peripheral surface of the bar 12B causes the expandable paper downstream of the bar 12B to expand, whereby as shown in FIG. 28D, the expanded slit sheet paper 1A can be wrapped around an item.

In the preferred embodiments, the expandable slit sheet paper withdrawn from the roll 1 of expandable slit sheet paper is initially directed in this manner over the bar 12B and below the bar 12A during the initial dispensing of the expandable slit sheet paper from the roll of slit sheet paper, while the diameter of the roll of expandable slit sheet paper is greater. Specifically, when the diameter of the roll of expandable slit sheet paper is greater, the bottom end of the roll of expandable slit sheet paper is appreciably below the height of the upper surface of the bar 12B. In this manner, as the expandable slit sheet paper is manually pulled over the peripheral surface of the bar 12B, the expandable slit sheet paper follows a substantially S curve from around a bottom of the roll 1 of slit sheet paper to around a peripheral surface over the upper side of the bar 12B as shown in FIG. 28D.

In some embodiments, a user initially pulls the expandable slit sheet paper along a path as shown in FIG. 28D. In some embodiments, the expandable slit sheet paper pulled along the path as shown in FIG. 28D will provide sufficient resistance until the diameter of the roll 1 of expandable slit sheet paper is too small such that the S curve of the expandable slit sheet paper is too minimal and/or the frictional contact between the surface of the expandable slit sheet paper and the bar 12B is too minimal due to a reduced arc of surface contact upon between the expandable slit sheet paper and the bar 12B.

In some embodiments, the dispenser 10 can include markings or indicia which identify a suitable diameter for the roll of expandable slit sheet paper that is appropriate for manually expanding the paper by pulling along the path shown in FIG. 28D. In some other embodiments, a user can ascertain whether pulling along the path shown in FIG. 28D is appropriate based on the extent of or the state of expansion of the expandable slit sheet paper downstream of the bar 12B. For example, in some embodiments, a user can begin by pulling the expandable slit sheet paper from a full roll along a path shown in FIG. 28D, and then the user can a) observe the perimeter of the roll with respect to a marker or indicator on the dispenser (such as, e.g., a marker along the sidewall 11A and/or 11B and/or b) observe the amount of expansion of the paper downstream of the bar 12B, and the user can adapt the path of the expandable slit sheet paper once the diameter of the roll is too small based on such observations.

For example, with reference to FIG. 28E, once the user determines that pulling along the path shown in FIG. 28D will not or does not provide sufficient tension to expand the expandable slit sheet paper, the user preferably reroutes the distal end of the expandable slit sheet paper such as to first extend over the bar 12A, and then to extend under the bar 12B such as to follow an S curve around the bars 12A and 12B as shown in FIG. 28E. In this manner, the combination of the bars 12A and 12B will, thus, present an increased frictional tension to facilitate expansion of the expandable slit sheet paper downstream of the bar 12B as shown in FIG. 28E.

When the roll 1 of expandable slit sheet paper1 has a narrow diameter (such as, e.g., shown in FIG. 28E), not only will the arc of contact with the bar 12B be reduced when the expandable slit sheet paper is pulled along the path between the bars 12A and 12B shown in FIG. 28D and not only will the frictional force exerted by the bar 12B between reduced, but the weight of the roll of expandable slit sheet paper 1 will also be reduced, whereby the frictional resistance imparted by the dispenser upon the rotation of the roll will also be reduced. Accordingly, redirecting the path of the expandable slit sheet paper to follow a path like that shown in FIG. 28E once the diameter of the roll is small will also help to accommodate for reduced resistance imparted against rotation of the roll 1 of expandable slit sheet paper upon the dispenser due to the weight of the roll 1.

In some embodiments, a tensioning mechanism TM, as shown in FIGS. 28E and 28F, that includes a tensioning bar similar to the tensioning bar 700 that applies frictional tension to resist rotation of the roll 1 on the core member 2 via spring and thumbscrew, as discussed above, can be employed. However, in some preferred embodiments, an additional tensioning mechanism TM is not required, and a suitable tension can be applied by virtue of selection of the desired path around the bars 12A and/or 12B, as described herein.

In some alternative embodiments, the selectable paths of the expandable slit sheet paper around the bars 12A and/or 12B can be varied from that shown in FIGS. 28A to 28F. By way of example, in some embodiments, a path solely extending over the top of the bar 12A can be implemented. As another example, in some embodiments, a path initially extending beneath the bar 12B, then extending backwards in between the bars 12A and 12B, and then extending forwards over the top of the bar 12B can be implemented. In various embodiments, a user can select different paths based on the corresponding frictional resistance applied to the expandable slit sheet paper pulled along such paths, which depends on, e.g., the arcs of the paper following around the corresponding bars 12A and/or 12B.

Although the embodiment shown in FIGS. 28A to 28F includes two bars 12A and 12B employed for imparting frictional resistance, around which a plurality of paths that each achieve differing frictional resistance can be employed, in some alternative embodiments three or more bars can be provided, including one or more additional bars fixed to said sidewalls 11A, 11B in a similar manner to the bars 12A, 12B. Additionally, in such alternative embodiments employing three or more bars, an even greater variety of other paths that achieve differing frictional resistances can be employed.

With reference to FIGS. 29A and 29B, these figures show a further embodiment employing novel systems and methods in which the path followed by the expandable slit sheet paper around the pair of bars is altered over time during dispensing such as to vary the tension applied during dispensing by adjusting the positions of the pair of cross-bars upon the dispenser.

In particular, in the embodiment shown in FIGS. 29A and 29B, a dispenser similar to that shown in FIGS. 28A to 28F is provided in which bars 12A′ and 12B′ are movably mounted on sidewalls 11A′ (notably, in the preferred embodiment, a second sidewall 11A′, not shown, is provided similarly to the sidewall 11A shown in FIGS. 28A to 28F) and/or 11B′.

Notably, in the embodiment shown in FIGS. 29A and 29B, the relative position of the bars 12A′ and 12B′ with respect to the roll 1 of expandable slit sheet paper can be adjusted, whereby the path of the expandable slit sheet paper around the bars 12A′ and/or 12B′ can be adjusted due to re-positioning of the bars 12A′ and 12B′, thus, resulting in adjustment of the frictional resistance imparted by the bars 12A′ and/or 12B′ upon the expandable slit sheet paper when manually pulled from the dispenser along a path having a region of contact around the periphery of the bars 12A′ and/or 12B′.

In some preferred implementations of the embodiment shown in FIGS. 29A and 29B, throughout the entire dispensing of expandable slit sheet paper from the roll 1 of expandable slit sheet paper, the paper follows a consistent path around the bars 12A′ and/or 12B′. However, after the diameter of the roll of expandable slit sheet paper decreases during use, in the embodiment of FIGS. 29A and 29B, the user preferably adjusts the position of the bars 12A′ and 12B′, whereby adjusting the frictional resistance imparted by the bars 12A′ and/or 12B′.

For example, in some embodiments, with reference to FIG. 29A, when the roll 1 of expandable slit sheet paper is of a large diameter (such as, e.g., upon initial placement of the roll on the dispenser), the expandable slit sheet paper can be made to follow a path similar to that shown in FIG. 28E, extending over the upper bar 12A′, downward and rearwardly between the upper bar 12A′ and the lower bar 12B′, and forwardly beneath the lower bar 12B′ similar to that shown in FIG. 28E.

During use, in some embodiments, when a) the diameter of the roll reaches a predetermined reduction in size and/or b) the slits of the expandable slit sheet paper do not fully expand, the user can adjust the positions of the bars 12A′ and 12B′ to adjust the frictional resistance imparted by the bars 12A′ and/or 12B′. As an illustrative example, as shown in FIG. 29B, in some embodiments, a user can raise the relative positions of the bars 12A′ and 12B′ to the increased height shown in FIG. 29B from the lower initial height shown in FIG. 29A.

In this raised position shown in FIG. 29B, the expandable slit sheet paper can continue to follow the path similar to that shown in FIG. 28E, extending over the upper bar 12A′, downward and rearwardly between the upper bar 12A′ and the lower bar 12B′, and forwardly beneath the lower bar 12B′ similar to that shown in FIG. 28E. However, due to the raised position of the bars 12A′ and 12B′, the expandable slit sheet paper extending from the roll 1 of expandable slit sheet paper will approach the upper bar 12A′ at a steeper angle, whereby the expandable slit sheet paper will follow around a greater arc around the periphery of the bar 12A′ resulting in a greater region of contact with the bar 12A′ and, thus, greater frictional resistance imparted by the bar 12A′ to the expandable slit sheet paper than if the bars 12A′ and 12B′ remained at the lower position shown in FIG. 29A despite the reduction in the size of the roll.

As with the embodiment shown in FIGS. 28A to 28F, in alternative variations of the embodiment of FIGS. 29A and 29B, the user can cause the expandable slit sheet paper to follow a different path around the bars 12A′ and/or 12B′.

Additionally, in alternative variations of the embodiment of FIGS. 29A and 29B, the user can adjust the frictional resistance applied by both a) adjusting the relative positions of the bars 12A′ and 12B′ and b) altering the path of the expandable slit sheet paper in a similar manner to that shown in FIGS. 28A to 28F.

Additionally, in alternative variations of the embodiment of FIGS. 29A and 29B, the dispenser can also include a tensioning mechanism TM, similar to that shown in FIG. 28E, providing for even further tension adjustability.

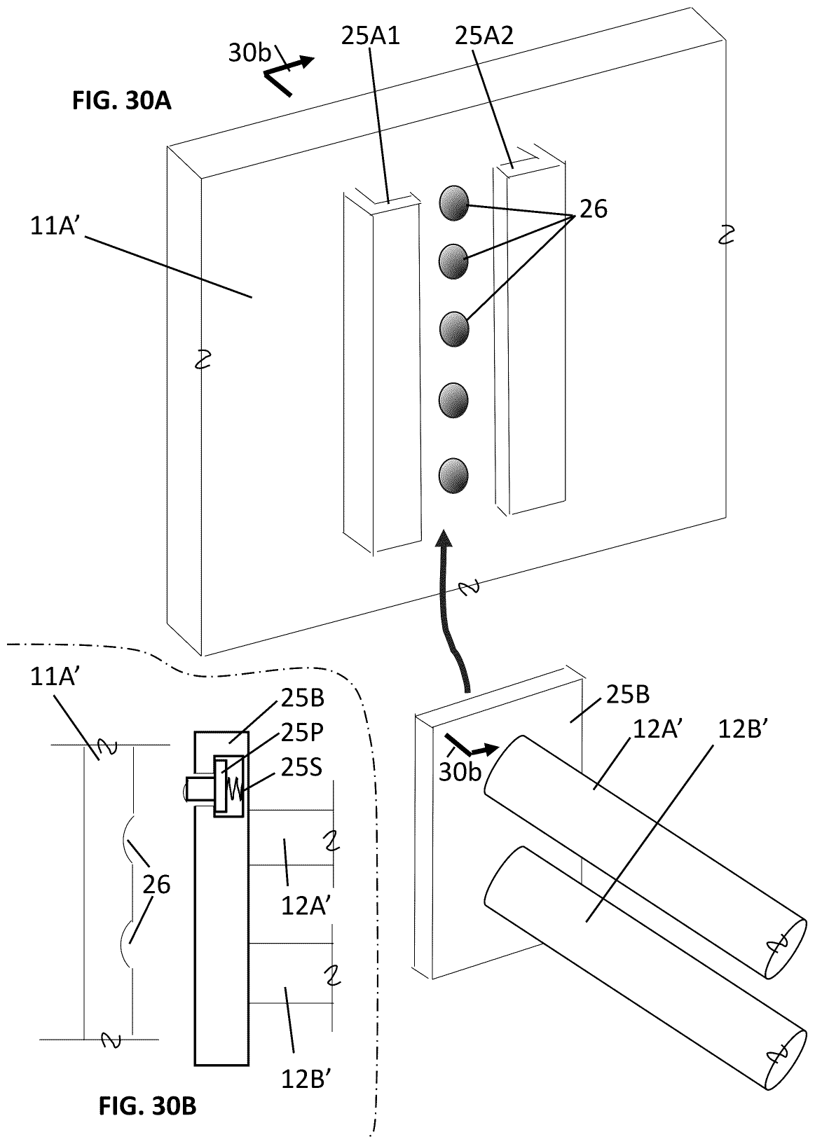

With reference to FIGS. 30A-30B, FIG. 31 and FIGS. 32A-32B, these figures show some illustrative mounts for movably mounting the bars 12A′ and 12B′ upon the sidewalls 11A′, 11B′.

With respect to FIGS. 30A-30B, these figures show a first illustrative mount that includes a track fixed to the sidewall 11A′, which includes opposing flanges 25A1 and 25A2 presenting a receiving track within which a bar support panel 25B, upon which the bars 12A′ and 12B′ are mounted, can fit and slide within the track. The bar support panel 25B has a width that fits within the track region between the opposing flanges 25A1 and 25A2, with the flanges overlapping opposite sides of the bar support panel 25B such as to retain the bar support panel 25B within the track. For example, the bar support panel 25B can be inserted within the track (see dark arrow shown in FIG. 30A) and raised or lowered within the track to a desired position.

In the embodiment shown in FIGS. 30A and 30B, the bar support panel 25B can be retained at a desired position within the track by implementation of a projection 25P supported on the bar support panel that is releasably engageable with a plurality of cup-shaped receiving openings 26 within the sidewall 11A′ along a length of the track as shown in FIG. 30A. In the illustrative embodiment, the projection 25P is moveably supported within a recess in the bar support panel 25B and is pressed in an outward direction via a spring 25S such that the projection 25P is biased by the spring to extend from a rear surface of the bar support panel 25B such as to be releasably engageable with a corresponding receiving opening 26. In operation, a user can set the position of the bar support panel 25B within the track by manually applying a raising or lowering force to the bar support panel that is sufficient to overcome the pressure of the spring 25S such that the projection 25P is caused to retract against the force of the spring 25S. As shown in FIG. 30B, in some preferred implementations the receiving openings 26 and the distal end of the projection 25P are formed with curved contours such that the projection 25B is vertically displaceable with respect to the sidewall 11A′, with the distal end of the projection 25P sliding along and out of the corresponding receiving opening 26 upon application of sufficient force to vertically move the projection 25P relative to the receiving opening 26 against the biasing force of the spring 25S.

Although the illustrative embodiment shown in FIGS. 30A and 30B includes five illustrative receiving openings 26, in various embodiments more or less receiving openings 26 can be provided.

Although not illustrated in FIGS. 30A and 30B, in some implementations the sidewall 11B′ can include a similar track and the opposite ends of the bars 12A′ and 12B′ can include a similar support panel that is received within the similar track in the sidewall 11B′. In some embodiments, the combination of the track on the sidewall 11B′, the support panel engaging such track, and the sidewall 11B′ can also include similar receiving openings and projections to that shown in FIGS. 30A and 30B. In some alternative variations, a track and support panel can be omitted at the sidewall 11B′.

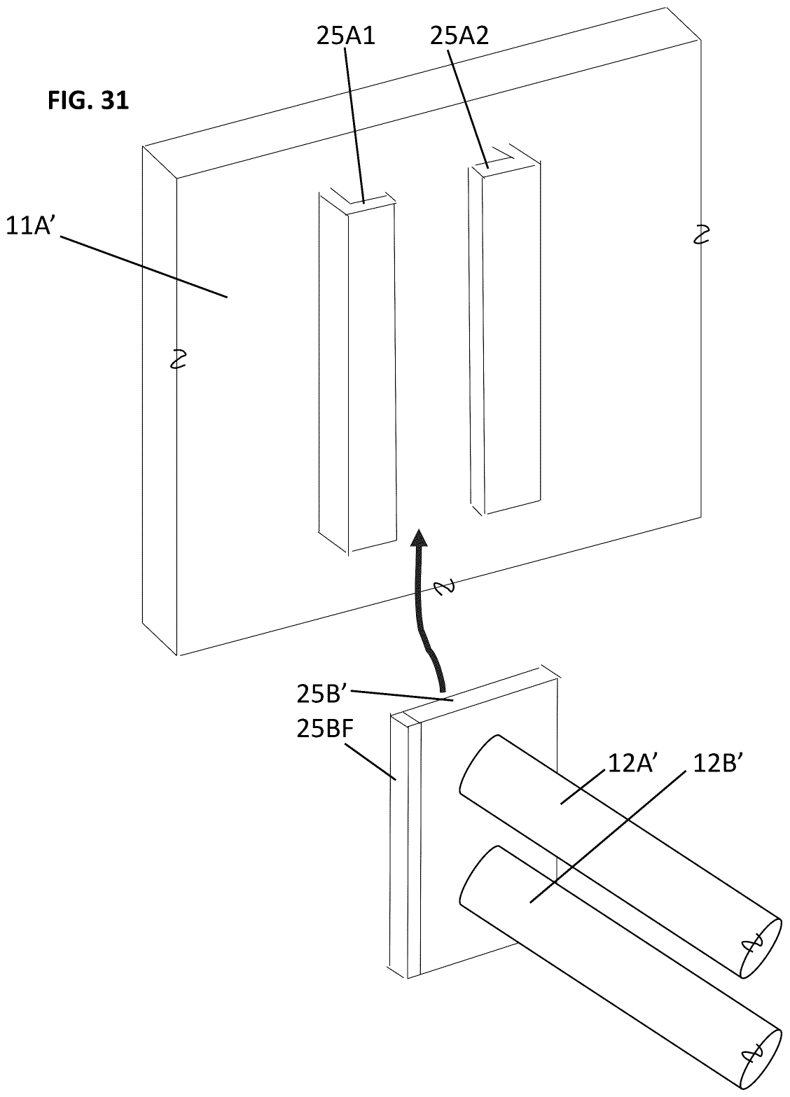

In various other embodiments, other mechanisms can be provided for adjustably fixing the relative positions of the bars 12A′ and 12B′ with respect to the sidewalls 11A′ and/or 11B′. For example, in some variations, the embodiment shown in FIGS. 30A and 30B can be modified as shown in FIG. 31, such as to include a modified support panel 25B′ that includes at least one friction element 25BF along one or more side thereof. In the embodiment shown in FIG. 31, the at least one friction element 25BF can include, for example, a rubber material, a foam material, a fabric material and/or another friction material that sufficiently frictionally engages within the track formed with the opposing flanges 25A1 and 25A2 such as to maintain the desired position of the bars 12A′ and 12B′ with respect to the sidewalls 11A′ and/or 11B′ until a user applies a sufficient manual force to move the support panel 25B′ relative to the track against the frictional applied by the at least one friction element 25BF.

In the embodiment shown in FIG. 31, rather than fixing the position of the bars 12A′ and 12B′ at discrete positions (such as, e.g., at positions corresponding to respective receiving openings 26 shown in FIGS. 30A and 30B), the bars 12A′ and 12B′ shown in FIG. 31 are fixable at any desired position along the length of the track.

Similar to the embodiment shown in FIGS. 30A and 30B, in the embodiment shown in FIG. 31, the sidewall 11B′ can include a similar track and the opposite ends of the bars 12A′ and 12B′ can include a similar support panel that is received within the similar track in the sidewall 11B′. In some embodiments, the combination of the track on the sidewall 11B′, the support panel engaging such track, and the sidewall 11B′ can also include similar features to that shown in FIG. 31 for frictionally maintaining the vertical position of the bars 12A′ and 12B′ relative to the sidewall 11B′. In some alternative variations, a track and support panel can be omitted at the sidewall 11B′.

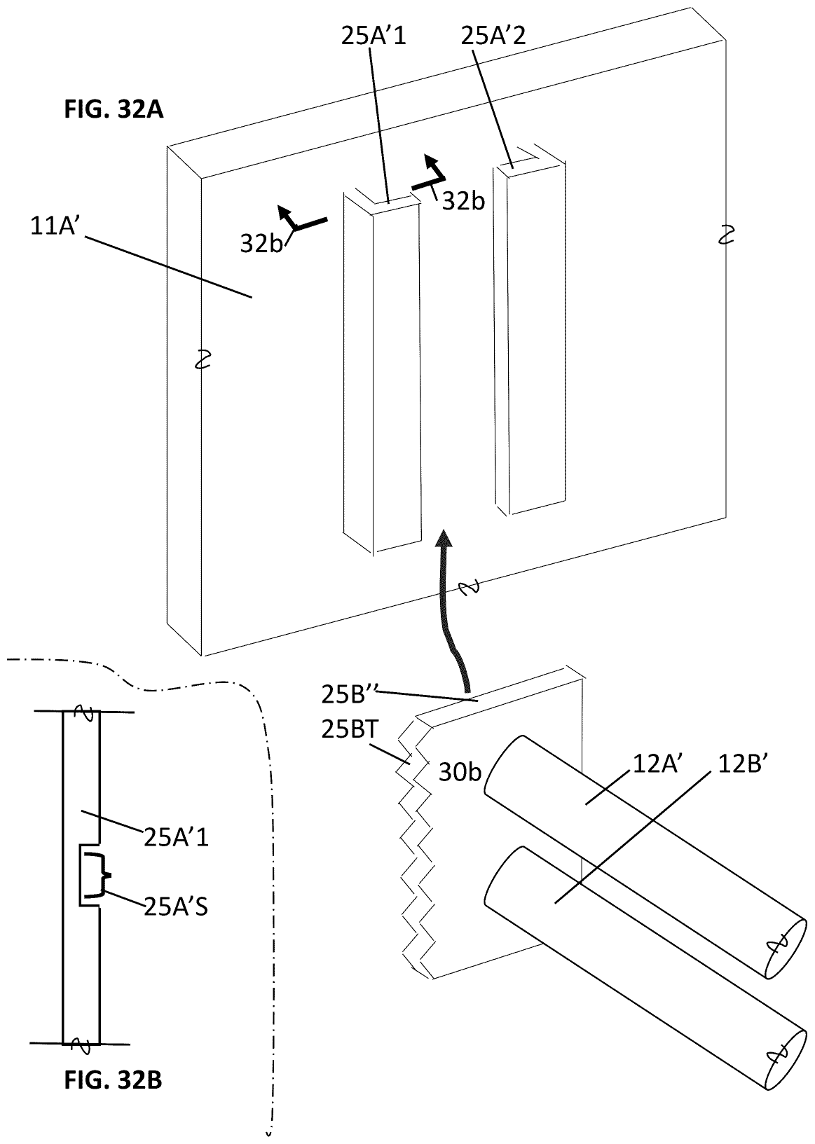

As another example, the embodiment shown in FIGS. 32A and 32B show another mechanism for adjustably fixing the relative position of the bars 12A′ and 12B′ with respect to the sidewalls 11A′ and/or 11B′ that is similar to the embodiment shown in FIG. 31, but in which the friction element 25BF of FIG. 31 is replaced with a varied or toothed surface 25BT that is engaged with a flexible positioner 25A'S within the flange 25A′1 that engages between teeth or irregularities in the surface 25BT to maintain the desired position of the bars 12A′ and 12B′ with respect to the sidewalls 11A′ and/or 11B′.

In the embodiment shown in FIGS. 32A and 32B, the bars 12A′ and 12B′ can be fixably located at positions separated at small intervals from one another by reducing the sizes of the teeth or irregularities that fix the location of the support panel 25B″.

Similar to the embodiments shown in FIGS. 30A-30B and FIG. 31, in the embodiment shown in FIGS. 32A-32B, the sidewall 11B′ can include a similar track and the opposite ends of the bars 12A′ and 12B′ can include a similar support panel 25B″ that is received within the similar track in the sidewall 11B′. In some embodiments, the track, support panel and sidewall 11B′ can also include similar features to that shown in FIGS. 32A-32B for frictionally maintaining the vertical position of the bars 12A′ and 12B′ relative to the sidewall 11B′. In some alternative variations, a track and support panel can be omitted at the sidewall 11B′.

Although the embodiments shown in FIGS. 30A-30B, FIG. 31 and FIGS. 32A-32B illustrate generally straight and generally vertical tracks for adjusting the positions of the bars, various embodiments can employ tracks that are arranged to enable movement the bars in non-vertical directions, such as, e.g., at an acute angle to the vertical direction, at a generally horizontal direction, or otherwise. Additionally, various embodiments can employ tracks or other mechanisms that enable non-linear movement of the bars with respect to the sidewalls, such as, e.g., following curved or arcuate paths or following irregular paths.

With reference to the embodiments shown in FIGS. 33 and 34, these further embodiments employ novel systems and methods in which the path followed by the expandable slit sheet paper around the pair of bars is altered over time during dispensing such as to vary the tension applied during dispensing by adjusting the position of one of the bars within the pair of bars upon the dispenser. Towards that end, in some embodiments, the position of one of the bars 12A, 12A′, 12B, 12B′ can be varied by employing any of the movable mounting mechanisms described herein in relation to the embodiments shown in any of FIGS. 30A-30B, FIG. 31 and/or FIG. 32A-32B. Additionally, as with the foregoing embodiments, the positions of one of the bars can be varied with respect to the sidewalls in any desired manner of movement, such as, e.g., following paths that are straight, curved, non-linear, vertical, non-vertical, horizontal, irregular, and/or otherwise arranged.

In the illustrative embodiment shown in FIG. 33, a lower bar 12B″ is shown that is movably mounted such as to be movable along a generally horizontal track 15″. In FIG. 33, a plurality (i.e., three) of illustrative positions of the lower bar 12B″ are depicted; it should be appreciated that these illustrated positions represent illustrative positions of the lower bar 12B″ at different points in time, and it should be appreciated that while three illustrative positions are depicted for reference, various embodiments can have numerous other positional variations in accordance with various embodiments of the invention described herein.

In the illustrative embodiment shown in FIG. 34, a lower bar 12B″ is shown that is movably mounted such as to be movable along non-vertical angled track 15″ (e.g., acutely angled to a vertical direction). In FIG. 34, a plurality of (i.e., three) illustrative positions of the lower bar 12B″ is similarly depicted; it should again be appreciated that these illustrative positions represent illustrative positions of the lower bar 12B″ at different points in time, and it should be appreciated that while three illustrative positions are depicted for reference, various embodiments can have numerous other positional variations in accordance with various embodiments of the invention described herein.

Although the embodiments shown in FIGS. 30A-30B, FIG. 31 and/or FIGS. 32A-32B involve bars that are mounted on a common support panel such as to be moved together and the embodiments shown in FIGS. 33 and 34 involve a single bar that is movably mounted, in some alternative embodiments the bars (e.g., 12A, 12B, 12A′, 12B′, 12A″, 12B″) can each be movably mounted, such that each of the bars can be moved relatively to the sidewalls of the dispenser. Towards that end, in such embodiments, each of the bars (e.g., 12A, 12B, 12A′, 12B′, 12A″, 12B″) can be adapted to move in accordance with any of the embodiments described herein and to follow any of the various paths in accordance with any of the embodiments described herein.

As with the foregoing embodiments, in variations of the embodiments of FIGS. 33 and 34, the user can cause the expandable slit sheet paper to follow any desired paths around the bars 12A″ and/or 12B″, including any of the paths described herein-above.

Additionally, as with the foregoing embodiments, in variations of the embodiments of FIGS. 33 and 34, the user can adjust the frictional resistance applied by both a) adjusting the relative position of the bar 12B″ and b) altering the path of the expandable slit sheet paper in a similar manner to that described herein-above.

Additionally, in other variations of the embodiments of FIGS. 33 and 34, the dispenser can also include a tensioning mechanism TM, similar to that shown in FIG. 28E, providing for even further tension adjustability.

Additionally, as with all of the embodiments shown in FIGS. 30A-30B, FIG. 31 and/or FIGS. 32A-32B, in the embodiments of FIGS. 33 and 34, the cross bars 12A″ and/or 12B″ can be made with a metal, such as, e.g., aluminum, stainless steel or other suitable metal. In other embodiments, the cross bars 12A″ and/or 12B″ can be made with other materials, such as, e.g., wood, ceramic, plastic and/or other suitable materials.

Additionally, as with all of the embodiments shown in FIGS. 30A-30B, FIG. 31 and/or FIGS. 32A-32B, in the embodiments of FIGS. 33 and 34, the cross bars 12A″ and/or 12B″ can be a) non-rotatably mounted on the sidewalls 11A′ and/or 11B′ or b) rotatably mounted on the sidewalls 11A and/or 11B. When the cross bars 12A″ and/or 12B″ are rotatably mounted on the sidewalls 11A′ and/or 11B′, rotation of the cross bars 12A″ and/or 12B″ is preferably inhibited (such as, e.g., via a friction applying mechanism) such as to facilitate application of frictional resistance to the surface of the expandable slit sheet paper extending around the peripheral surface of the cross bars 12A″ and/or 12B″ upon manual pulling of the expandable slit sheet paper.

With reference to the embodiments shown in FIGS. 35 to 39, these embodiments employ novel systems and methods in which the path followed by the expandable slit sheet paper around a single bar is altered over time during dispensing such as to vary the tension applied during dispensing by adjusting the position of the single bar upon the dispenser. Among other things, the embodiments shown in FIGS. 35 to 39 can advantageously reduce the number of bars employed for imparting friction. Additionally, the embodiments shown in FIGS. 35 to 39 can advantageously provide systems and methods in which the paths followed by the expandable slit sheet paper can be consistently maintained in relation to a single bar and in which more complicated manual manipulation of the expandable slit sheet paper around multiple bars is not required for dispensing and expansion.

In the illustrative embodiment shown in FIG. 35, a single bar 12Aa is shown that is movably mounted such as to be movable along a generally vertical track 15a. Towards that end, in some embodiments, the position of the bar 12Aa can be varied by employing any of the movable mounting mechanisms described herein in relation to the embodiments shown in any of FIGS. 30A-30B, FIG. 31 and/or FIG. 32A-32B.

In FIG. 35, a plurality (i.e., three) of illustrative positions of the bar 12Aa is depicted; it should be appreciated that these illustrative positions represent illustrative positions of the bar 12Aa at different points in time, and it should be appreciated that while three illustrative positions are depicted for reference, various embodiments can have numerous other positional variations in accordance with various embodiments of the invention described herein.

As with the foregoing embodiments, in variations of the embodiment of FIGS. 35, the user can cause the expandable slit sheet paper to follow a desired path around the bar 12Aa. For example, in some preferred embodiments, the expandable slit sheet paper extends from a bottom of the roll 1 of expandable slit sheet paper and then extends over the bar 12Aa, such that the expandable slit sheet paper frictionally engages a peripheral surface of the bar 12Aa within a desired arc around the periphery of the bar 12Aa. In some embodiments, the expandable slit sheet paper extends from a top of the roll 1 of expandable slit sheet paper and then extends under the bar 12Aa, such that the expandable slit sheet paper frictionally engages a peripheral surface of the bar 12Aa within a desired arc around the periphery of the bar 12Aa.

In some preferred implementations, the path of the expandable slit sheet paper from around the roll 1 of expandable slit sheet paper to around the bar 12Aa is generally S shaped, with a first curvature of the S shape extending around the roll to a tangent line at which the expandable slit sheet paper separates from the roll 1, and then extends to a tangent at a perimeter of the bar 12Aa, and then extends in an arc around the periphery of the bar 12Aa creating a second curvature of said S shape, and then separates from the bar 12Aa at another tangent to said roll (e.g., extending to a position at which a user manually gasps a distal end of the expandable slit sheet paper).

Similar to embodiments described above, in the embodiment of FIG. 35, the user can adjust the frictional resistance applied by adjusting the relative position of the bar 12Aa.

Additionally, in other variations of the embodiment of FIG. 35, the dispenser can also include a tensioning mechanism TM, similar to that shown in FIG. 28E, providing for even further tension adjustability.

Additionally, as with all of the embodiments described herein-above, in the embodiment of FIG. 35, the cross bars 12Aa can be made with a metal, such as, e.g., aluminum, stainless steel or other suitable metal. In other embodiments, the cross bar 12Aa can be made with other materials, such as, e.g., wood, ceramic, plastic and/or other suitable materials.

Additionally, as with all of the embodiments described herein-above, in the embodiment of FIG. 35, the cross bar 12Aa can be a) non-rotatably mounted on the sidewalls or b) rotatably mounted on the sidewalls. When the cross bar 12Aa is rotatably mounted on the sidewalls, rotation of the cross bars 12Aa is preferably inhibited (such as, e.g., via a friction applying mechanism) such as to facilitate application of frictional resistance to the surface of the expandable slit sheet paper extending around the peripheral surface of the cross bars 12A and/or 12B upon manual pulling of the expandable slit sheet paper.

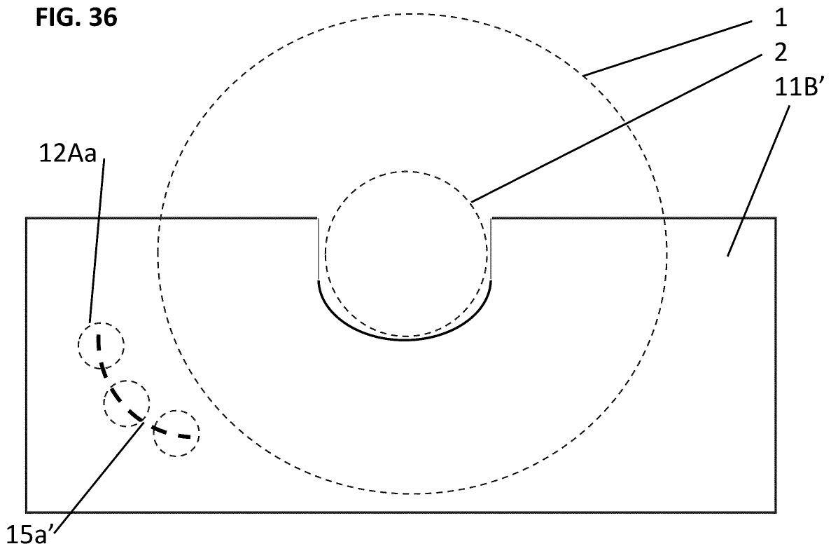

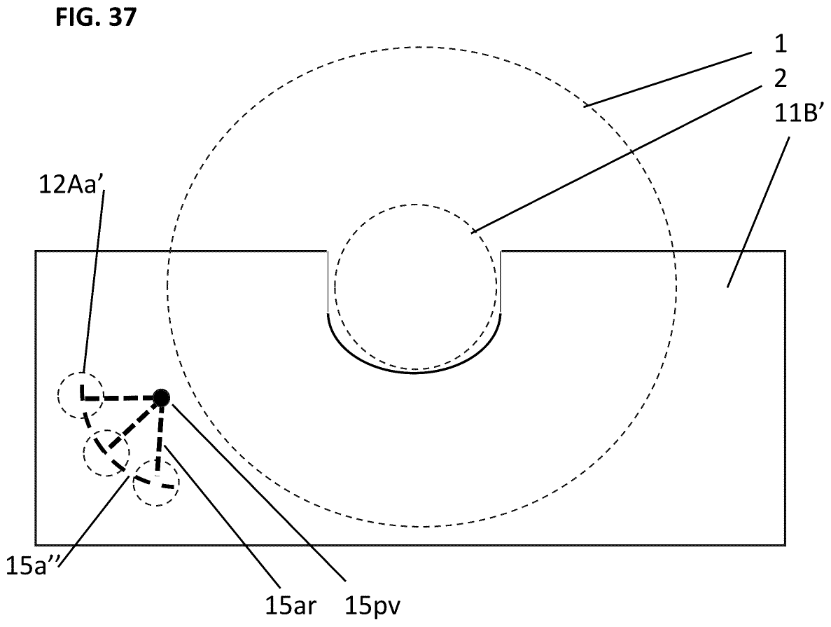

Additionally, although the position of the bar 12Aa is adjusted along a generally vertical path in the embodiment of FIG. 35, as with the foregoing embodiments, the position of the bar 12Aa can be varied with respect to the sidewalls in any desired manner, such as, e.g., following paths that are straight, curved, non-linear, vertical, non-vertical, horizontal, irregular, and/or otherwise arranged. For example, in the embodiment shown in FIG. 36, the bar 12Aa is adapted to move along a curved path 15a′. It should be appreciated that the bar 12Aa can be adapted to move along a curved path 15a′ employing a variety of mounts, such as, e.g., a curved track similar to the tracks described herein-above, but employing a curved track rather than a straight track. As another example, in the illustrative embodiment shown in FIG. 37, the bar 12Aa′ is caused to follow a curved path 15a″ by pivotally mounting the bar 12Aa′ to the sidewalls 11A′ and/or 11B′. For example, in the illustrative embodiment shown in FIG. 37, the bar 12Aa′ is mounted to at least one lever arm 15ar that is pivotally connected to the sidewalls 11A′ and/or 11B′. For example, in some implementations, the bar 12Aa′ can include lever arms attached at each end of the bar 12Aa′, with respective lever arms attached to respective sidewalls 11A′ and 11B′. In various embodiments, the angular positions of the lever arm(s) 15ar can be fixed in desired positions employing a ratchet mechanism or employing mechanisms like that employed in any of FIGS. 30A-30B, FIG. 31, and FIGS. 32A-32B.

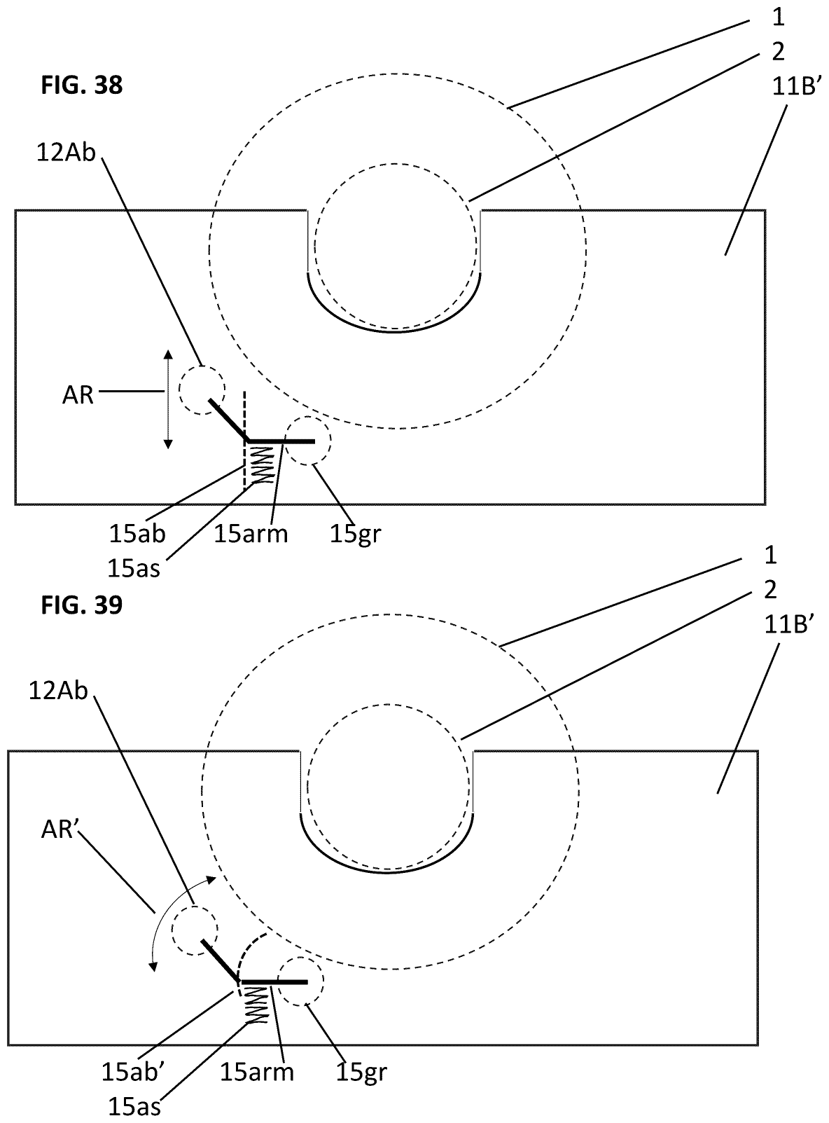

In the foregoing embodiments, the positions of the bars (e.g., 12A′, 12B′, 12A″, 12B″, 12Aa, 12Aa′) are manually adjusted by the user. However, in some alternative embodiments, the positions of the bars can be—alternatively or additionally—mechanically or automatically adjusted by the device. For example, in the embodiments shown in FIGS. 38 and 39, the position of a bar 12Ab is mechanically adjusted to vary its position depending on the diameter of the roll 1 of expandable slit sheet paper.

In the embodiment shown in FIG. 38, a bar support mechanism is provided that includes a support arm 15arm that is movably mounted along a track 15ab (which track can be similar to any of the tracks as described herein-above). In the preferred construction of the embodiment of FIG. 38, the support arm 15arm supports the bar 12Ab which is mounted thereto. In the preferred embodiments, the bar 12Ab can be made similarly to any of the bars (e.g., 12A′, 12B′, 12A″, 12B″, 12Aa, 12Aa′) described above. Additionally, in the preferred construction of the embodiment of FIG. 38, the support arm 15arm includes a rotatable wheel 15gr that is configured to press against and roll upon a peripheral surface of the roll 1 of expandable slit sheet material (preferably, pressing at a location around the periphery of the roll 1 prior to separation of the expandable slit sheet paper from the roll 1), such as to rest upon the surface of the roll 1 and to rotate along with the rotation of the roll 1. Additionally, in the preferred construction of the embodiment of FIG. 38, a spring 15as is preferably provided that upwardly biases the arm 15arm such that the rotated wheel 15gr presses against the peripheral surface of the roll 1 of expandable slit sheet material. In this manner, the position of the rotatable wheel 15gr will move along with the position of the peripheral surface of the roll 1 of expandable slit sheet material, which position will move as the size of the roll decreases due to dispensing of the expandable slit sheet material. Additionally, because the bar 12Ab is mounted to the arm 15arm, the position of the bar 12Ab will, thus, also be concurrently mechanically adjusted such as to follow in accordance with the adjustment of the position of the rotatable wheel 15gr. In this manner, the position of the bar 12Ab is automatically mechanically adjusted, whereby enabling the friction applied by the bar 15arm to be adjusted throughout the dispensing of the expandable slit sheet material from the roll of expandable slit sheet material.

Although the embodiment shown in FIG. 38 depicts a single bar 12Ab, in other variations of the embodiment shown in FIG. 38, the arm can support multiple bars, such that the bars can move in a similar manner to that of the embodiment shown in FIGS. 29A-29B and/or in a similar manner to any of the embodiments described herein-above.

Additionally, in other variations of the embodiment of FIG. 38, the dispenser can also include a tensioning mechanism TM, similar to that shown in FIG. 28E, providing for even further tension adjustability.

Additionally, as with all of the embodiments described herein-above, in the embodiment of FIG. 38, the cross bar 12Ab can be made with a metal, such as, e.g., aluminum, stainless steel or other suitable metal. In other embodiments, the cross bar 12Ab can be made with other materials, such as, e.g., wood, ceramic, plastic and/or other suitable materials.

Additionally, as with all of the embodiments described herein-above, in the embodiment of FIG. 38, the cross bar 12Ab can be a) non-rotatably mounted on the support arm 15arm or b) rotatably mounted on the support arm 15arm. When the cross bar 12Ab is rotatably mounted on the arm 15arm, rotation of the cross bar 12Ab is preferably inhibited (such as, e.g., via a friction applying mechanism) such as to facilitate application of frictional resistance to the surface of the expandable slit sheet paper extending around the peripheral surface of the cross bar 12Ab.

Additionally, although the position of the bar 12Ab is adjusted along a generally vertical path in the embodiment of FIG. 38, as with the foregoing embodiments, the position of the bar 12Ab can be varied in any desired manner, such as, e.g., following paths that are straight, curved, non-linear, vertical, non-vertical, horizontal, irregular, and/or otherwise arranged. For example, in the embodiment shown in FIG. 39, the bar 12Ab is adapted to move along a curved path 15ab′. It should be appreciated that the bar 12Ab can be adapted to move along a curved path 15ab′ employing a variety of mounts, such as, e.g., a track similar to the tracks described herein-above, but employing a curved track rather than a straight track. As another example, in the illustrative embodiment shown in FIG. 39, the bar 12Ab′ can be caused to follow a curved path 15ab′ by pivotally mounting the arm 15arm to the sidewalls 11A′ and/or 11B′ and having the rotatable wheel 15gr press against the side of the roll 1 (e.g., by virtue of a force of a spring 15as) to maintain the angular position of the arm 15arm.

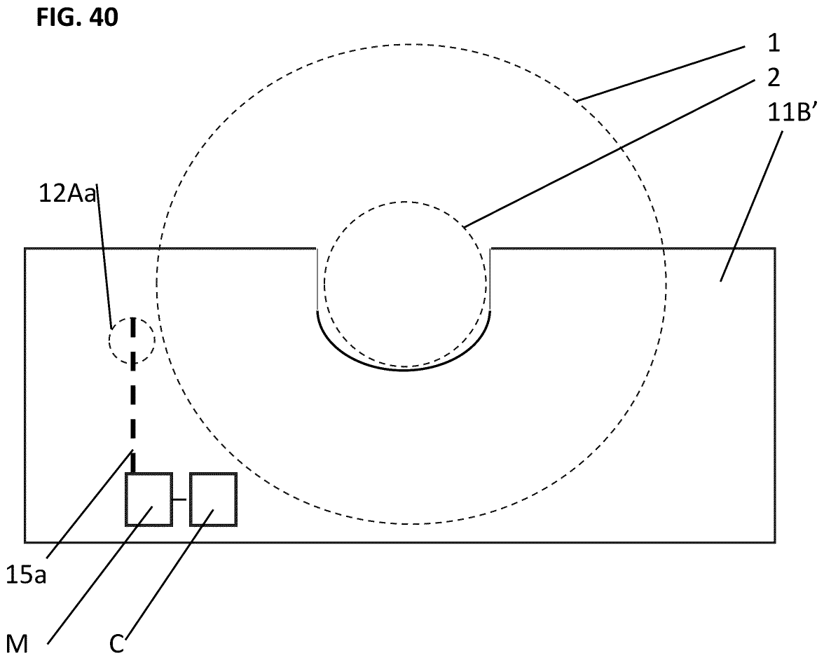

As indicated above, in addition to embodiments like that described above with reference to FIGS. 38 and 39 in which the positions of the bar(s) are automatically adjusted mechanically by the device, in some embodiments, the position of a bar 12Ab can be automatically adjusted using an automated control system. For example, in the illustrative embodiment shown in FIG. 40, the position of a bar 12Ab is vertically adjusted along a track or path 15a employing an electronic moving mechanism M that is controlled via a controller C (e.g., employing a computer processor and/or the like), which can be powered via an external electronic power source or the like. In some illustrative embodiments, the electronic moving mechanism M can include an electric motor that rotates a threaded shaft which, in turn, causes the bar 12Ab to be raised and/or lowered upon rotation of the threaded shaft. In some other illustrative embodiments, the electronic moving mechanism M can include a solenoid that moves the position of the bar 12Ab. In some embodiments, the controller C can be configured to control the operation of the electronic moving mechanism M such as to control the position of the shaft 12Ab based on user input, based on pre-programming, based on detection of the diameter of the roll 1 of expandable slit sheet paper or the amount of expandable slit sheet paper dispensed from the roll 1, and/or based on detection of an amount of resistance or rotation of the roll 1 of expandable slit sheet paper.

In various alternative variations of the foregoing embodiments, any and all of the foregoing embodiments described herein-above can be adapted to include a similar automated control system to that described in relation to FIG. 40.

### Fourth Embodiment

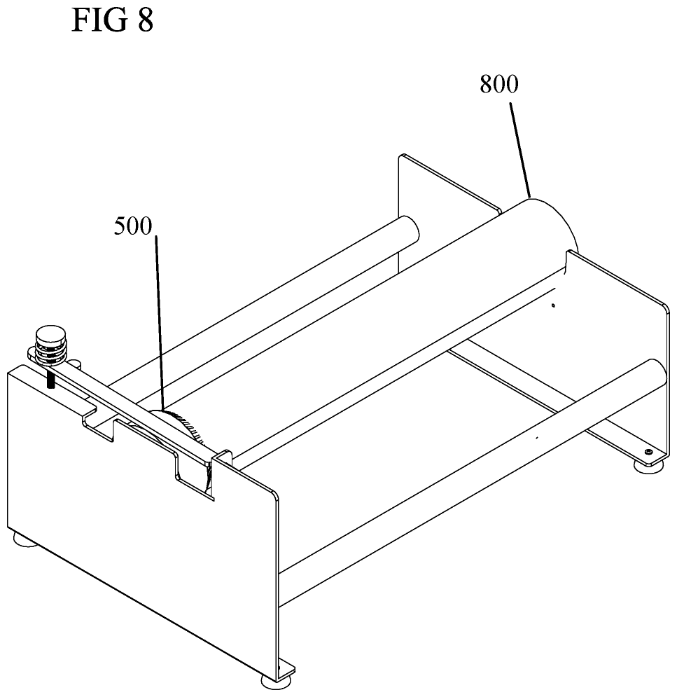

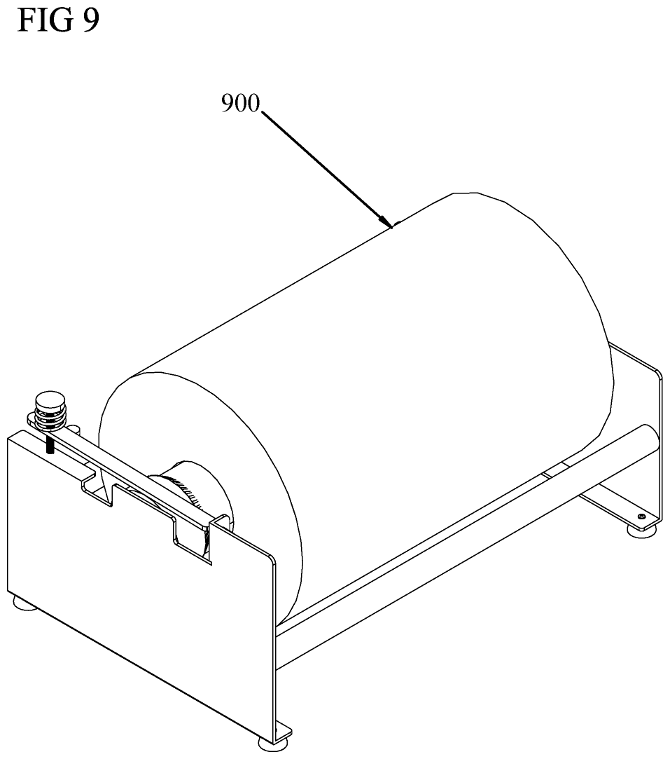

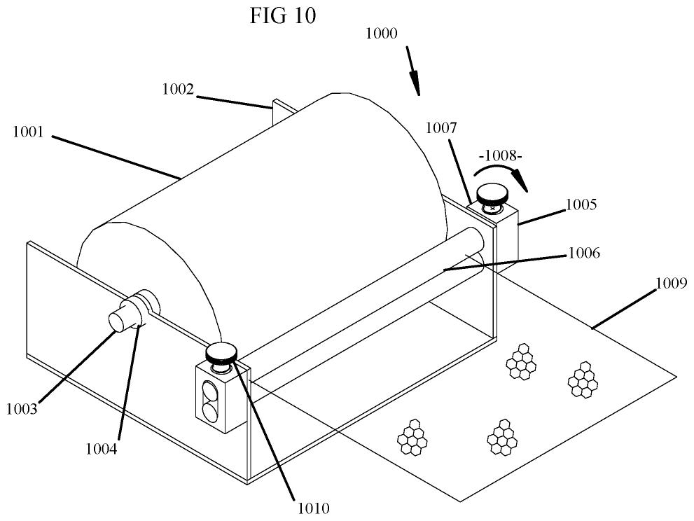

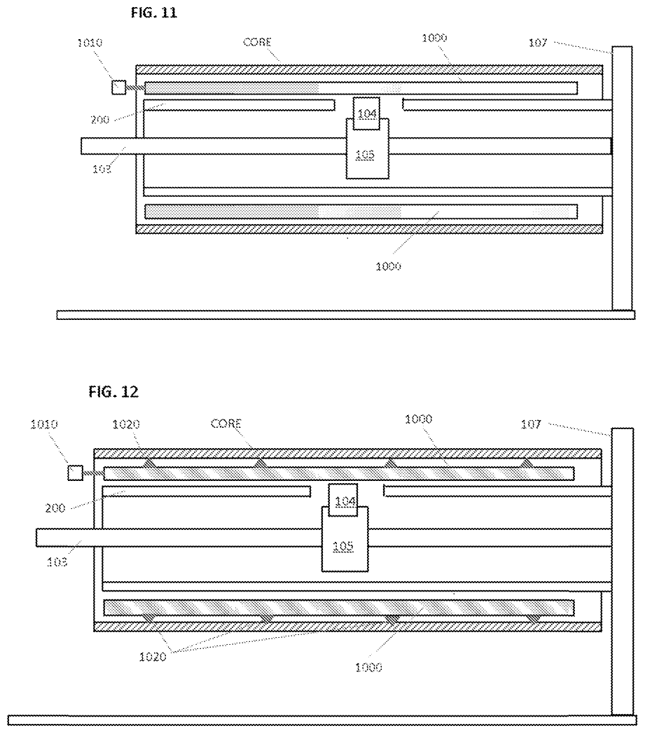

FIGS. 11-12 show a fourth embodiment which is similar to the embodiment shown in FIGS. 1-4, with the addition of an intermediary sleeve 1000 in between the sleeve 200 and the core (CORE), around which the paper roll is supported.

In the embodiment shown in FIGS. 11-12, rotation of the shaft 103 similarly cases rotation of a cam block 105, such as to raise/lower a shim 104. In some embodiments, these features can be similar to that shown in FIGS. 1-4. Moreover, other elements of the embodiment shown in FIGS. 1-4 can also be employed, such as, e.g., the use of a turning knob, etc. In the embodiment of FIGS. 11-12, rather than pressing against the interior of the core (CORE), the shim 104 is pressed against the intermediary sleeve 1000. In this manner, as with the embodiment shown in FIGS. 5-9, this embodiment shown in FIGS. 11-12 does not need to rely on features of the paper core for affecting the desired tensioning or resistance because tensioning or resistance is a result of sliding frictional engagement between an interior of the intermediate sleeve 1000 and the shim 4. As with the embodiment shown in FIGS. 5-9, the intermediate sleeve 1000 can be made with metal and/or other suitable materials (similar to material of insert 500 shown in FIG. 5).

In operation, as with the embodiment shown in FIGS. 5-9, the intermediate sleeve 1000 is preferably fixed with respect to core (CORE) such as to rotate with the rotation of the core. In some embodiments, the intermediate sleeve 1000 include projectable members 1020 that are configured to be retracted to a retracted state as shown in FIG. 11 and to be extended to a projected state as shown in FIG. 12. In the retracted state shown in FIG. 11 the intermediate sleeve 1000 is readily received within the core (CORE). On the other hand, once the core is inserted over the intermediate sleeve 1000, the projectable members 1020 can be extended to the projected state as shown in FIG. 12 such as to lock or fixedly be retained within respect to the interior of the core. In this manner, the intermediate sleeve 1000 will rotate along with the rotation of the core.

As shown in FIGS. 11-12, a projection mechanism 1010 is provided that is used to effect movement of the projectable members 1020. In various embodiments, the projection mechanism and the projectable members 1020 can be made of any known projection mechanisms and projectable members. For example, in some embodiments, the mechanism 1010 can include an air bladder that is used to pump air through a valve into expandable members 1020, along with a release valve that is opened to release air such as to retract the projectable members 1020. As another example, the extendable members can be pivotally mounted within an exterior groove on the intermediate sleeve 1000, and the mechanism 1010 can include an actuator shaft that pushes the extendable members, such that the extendable members pivot outwardly to engage the interior of the core. Then, to retract the members 1020, the actuator shaft can be moved in a reverse direction to retract the members 1020. In some illustrative embodiments, such an actuator shaft can include threads and the mechanism 1010 can involve a manually rotated knob that is rotated to cause the projectable members 1010 to move accordingly.

### Fifth Embodiment

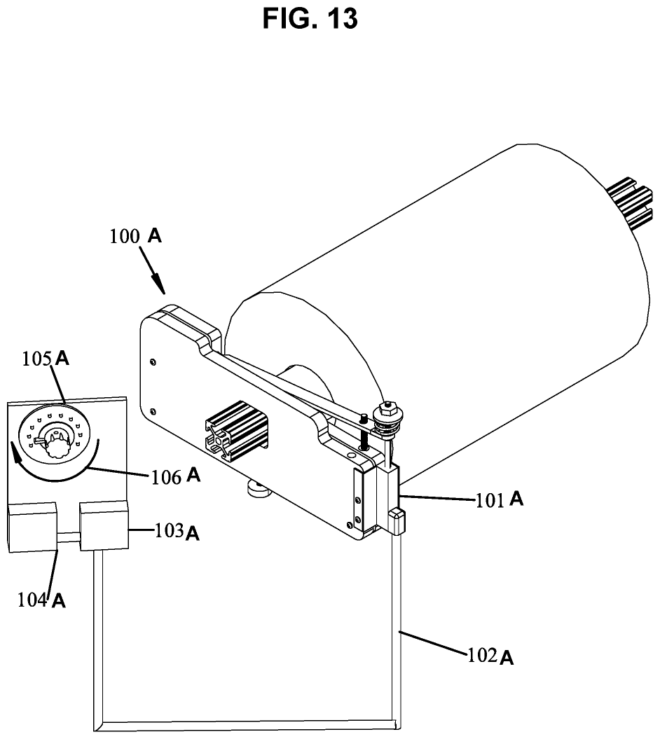

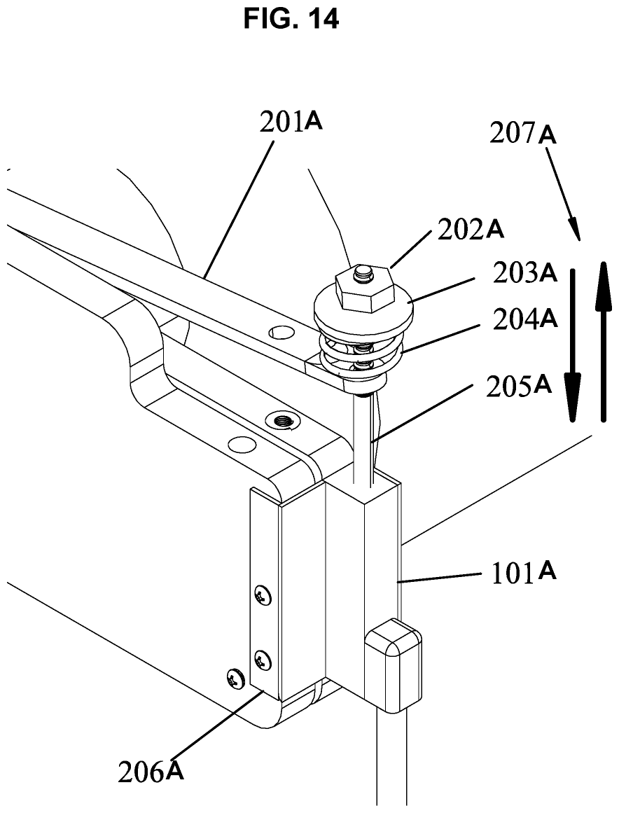

A fifth embodiment of the invention is shown in FIGS. 13-14. As shown in FIGS. 13-14, in some embodiments, the tensioning device can be adjusted or controlled via an automated mechanism rather than via a direct manual control.

Additionally, in some embodiments, a computer controller can also be provided that automatically adjusts the applied tensioning to a desired range or within a desired limit.

In various embodiments, automated aspects of this fifth embodiment can be implemented within any other embodiment of the invention shown herein. In some embodiments, with respect to embodiments like that shown in FIGS. 5-9 and 11-12, in which friction is applied between components other than the core, the frictional variation can be within a more limited range than when friction is applied against a paper core. Accordingly, automated control within such embodiments can achieve a smooth consistency for ease of use.

For the purposes of the present invention, the term “worm motor drive” as employed herein, refers to an electrical system by which a shaft will move upwards or downwards by electrical input.

For the purposes of the present invention, the term “control switch” refers to an electrical device than can adjust the worm gear motor to cycle up or down either by turning a knob or pressing an up or down button.

For the purposes of the present invention, the term “worm gear” refers to an electrical motor that can push a rod up and down. A motor of this type can be driven by air pressure and other designs that are found commonly within the art to move a shaft back and forth or up and down.

In the preferred implementations of this fifth embodiment, a time-saving solution for adjusting the position and, therefore, pressure exerted by a tensioning device is provided (such as, e.g., tension rod against a paper core around which the expanded slit sheet material is wound). According to some embodiments described herein, a tensioning device is adjusted by hand (for example, a thumbscrew is manually adjusted or turned by hand which in turn puts pressure on a spring). The spring in turn puts pressure on the tension rod and then finally onto the paper core.

This manual process is very easy and successful when the dispenser is on the packing table and within a short distance from the packer. According to this fifth embodiment, a power tension system is provided. For example, in some implementations, this new art can be employed to apply a powered tension system in the even that the unit is placed too far away for the packer (i.e., the individual operating the device) to easily operate the device by hand (e.g., to turn the thumbscrew by hand). In this case, the packer would have a controller that can control the tensioning via an automated system, such as, e.g., to either raise or lower a motor worm gear to add or subtract tension as needed.

The worm gear motor is the preferred device among a number of devices such as, a stepper motor, compressed air cylinder, jackscrew motor, etc., that could be used to apply pressure on the paper core (not numbered but shown in part in FIG. 13) by movement of tension rod 201A (FIG. 14) or other member to apply resistance against movement of the roll (e.g., by applying pressure against the paper core or otherwise apply resistance as described in various other embodiments set forth in this application).

FIG. 13 is a perspective view of an illustrative slit sheet paper dispensing system 100A that shows the position of a worm drive 101A as it sits on the front of the dispenser. It is electrically connected to the drive controller 103A via cabling 102A which, is connected by cabling to power supply 104A. In some illustrative examples, the control switch 105A is operated to cause the system to operate. For example, in some examples, the control switch 105A can be moved in clockwise direction 106A to cause the system to lift the tension rod upward and counterclockwise to cause the system to lower the tension rod.

FIG. 14 is a perspective view and close-up view of the worm gear 101A as its fixed in position with bracket 206A. Worm gear shaft 205A is passed through a hole in tension rod 201A and through spring 204A and through washer 203A and is threaded on top to receive locking nut 202A. As the packer desires to increase or decrease tension by using control switch 105A in FIG. 13, not shown, the worm shaft 105A will move in an upward or downward direction as depicted with vertical arrows 207A.

While FIGS. 13-14 show an illustrative automated system for automated application of and adjustment of tensioning, it should be appreciated that the automated system shown in FIGS. 13-14 is merely an illustrative example and that various other embodiments can use other components for automated control of the tensioning.

Additionally, although FIGS. 13-14 show automated control of a tensioning employed in an embodiment in which tensioning is applied to a paper core or the like, other embodiments can employ automated control of tensioning in the context of any of the expander devices described in this present application.

### Definitions Relating to Some Preferred Embodiments

For the purposes of the present invention the term “paper roll” describes a slit sheet material wound around a core (such as, e.g., a paper core).

For the purposes of the present invention, the term “yoke” includes a structure contoured or shaped to support or carry a load.

For the purposes of the present invention, the term “rod” includes an elongated or straight element that is longer than it is wide and that is sufficiently rigid to support a roll of expandable slit paper. The term “rod” is inclusive of a slender bar, a pole, rod, shaft, strut, and a beam.

For the purposes of the present invention, the term “core support member” includes a structure that contacts an interior of a core member and bears the weight of a roll of paper that is wound around the core member by having the weight borne from the interior of a hollow core member.

For the purposes of the present invention, the term “paper core” includes a paper tube around which the expandable slit sheet paper is wound and “interior core member” includes that the core member has slit-expandable paper wound around the core member and is interior to the roll of paper.

For the purposes of the present invention, the term “curvature” includes an arcuate or essentially circular configuration that is shaped or curved like an arc or bow.

For the purposes of the present invention, the term “tensioning mechanism” includes a pressure assembly that applies pressure to variably increase or decrease friction and thereby variably resistance the unwinding the paper from the roll. The friction provides a rotational resistance that causes the slit paper to expand as it is drawn from the roll of slit sheet paper.

For the purposes of the present invention, the term “attached” means securely fixing one part to another as in the art of assembling wood, wood composites, metals, or plastics in order to create a bolted, screwed, secured, fastened, or sealed assembly and is inclusive of permanent assemblies and configurations that can be disassembled. Moreover, being “attached” does not require a direct connection between elements, but can include attachment via an intermediary member.

For the purposes of the present invention, the term “shim” includes, e.g., a thin, often tapered piece of material (such as wood, metal, or stone) used to fill in space between elements or components (such as, e.g., for support, leveling and/or adjustment of fit). In some examples, a shim can function as a wedge between two structures and can create a little extra height or a little extra space.

### Broad Scope of the Invention

Within this application, the use of individual numerical values is stated as approximations as though the values were preceded by the word “about”, “substantially”, or “approximately.” Similarly, the numerical values in the various ranges specified in this application, unless expressly indicated otherwise, are stated as approximations as though the minimum and maximum values within the stated ranges were both preceded by the word “about”, “substantially”, or “approximately.” In this manner, variations above and below the stated ranges can be used to achieve substantially the same results as values within the ranges. As used herein, the terms “about”, “substantially”, and “approximately” when referring to a numerical value shall have their plain and ordinary meanings to a person of ordinary skill in the art to which the disclosed subject matter is most closely related or the art relevant to the range or element at issue. The amount of broadening from the strict numerical boundary depends upon many factors. For example, some of the factors which may be considered include the criticality of the element and/or the effect a given amount of variation will have on the performance of the claimed subject matter, as well as other considerations known to those of skill in the art. As used herein, the use of differing amounts of significant digits for different numerical values is not meant to limit how the use of the words “about”, “substantially”, or “approximately” will serve to broaden a particular numerical value or range. Thus, as a general matter, “about”, “substantially”, or “approximately” broaden the numerical value. Also, the disclosure of ranges is intended as a continuous range including every value between the minimum and maximum values plus the broadening of the range afforded by the use of the term “about”, “substantially”, or “approximately”. Thus, recitation of ranges of values herein are merely intended to serve as a shorthand method of referring individually to each separate value falling within the range, unless otherwise indicated herein, and each separate value is incorporated into the specification as if it were individually recited herein. To the extent that determining a given amount of variation of some the factors such as the criticality of the slit patterns, paper width differential pre- and post-expansion, paper weights and type, as well as other considerations known to those of skill in the art to which the disclosed subject matter is most closely related or the art relevant to the range or element at issue will have on the performance of the claimed subject matter, is not considered to be within the ability of one of ordinary skill in the art, or is not explicitly stated in the claims, then the terms “about”, “substantially”, and “approximately” should be understood to mean the numerical value, plus or minus 15%.

All U.S. and foreign patents, patent applications, patent publications, and all other publications cited in this application are incorporated herein by reference in this application in their entireties as though recited herein in full.

What is claimed is:

1. A method of adjusting frictional resistance of an expandable slit sheet paper dispensed from a manual dispenser, comprising:
supporting a roll of expandable slit sheet paper on a frame of the dispenser, said roll of expandable slit sheet paper having an initial diameter;
manually pulling a distal end of the roll of expandable slit sheet paper from a perimeter of said roll such that the expandable slit sheet paper extends along an arc around a portion of a periphery of at least one bar that extends across a width of said expandable slit sheet paper, whereby applying a frictional resistance to the expandable slit sheet paper that causes said expandable slit sheet paper to expand and form open cells; and
after dispensing expandable slit sheet paper from said roll such that a diameter of said roll is reduced from said initial roll diameter, adjusting said frictional resistance to the expandable slit sheet paper that causes said expandable slit sheet paper to expand and form open cells by altering a path of the expandable slit sheet paper around said at least one bar such as to increase the frictional resistance applied to the expandable slit sheet paper.

2. The method of claim 1, further including altering said path of the expandable slit sheet paper around said at least one bar such as to increase the frictional resistance applied to the expandable slit sheet paper by:
a) manually altering the path of the expandable slit sheet paper around the at least one bar such as to increase the frictional resistance applied to the expandable slit sheet paper; and/or
b) adjusting a position of at least one of said at least one bars such as to increase the frictional resistance applied to the expandable slit sheet paper.

3. A method of adjusting frictional resistance of an expandable slit sheet paper dispensed from a manual dispenser, comprising:
supporting a roll of expandable slit sheet paper on a frame of the dispenser, said roll of expandable slit sheet paper having an initial diameter;
manually pulling a distal end of the roll of expandable slit sheet paper from a perimeter of said roll such that the expandable slit sheet paper extends along an arc around a portion of a periphery of at least one bar that extends across a width of said expandable slit sheet paper, whereby applying a frictional resistance to the expandable slit sheet paper that causes said expandable slit sheet paper to expand and form open cells; and
after dispensing expandable slit sheet paper from said roll such that a diameter of said roll is reduced from said initial roll diameter, adjusting said frictional resistance to the expandable slit sheet paper that causes said expandable slit sheet paper to expand and form open cells by:
a) manually altering a path of the expandable slit sheet paper around said at least one bar such as to increase the frictional resistance applied to the expandable slit sheet paper; and/or
b) adjusting a position of at least one of said at least one bars such as to increase the frictional resistance applied to the expandable slit sheet paper.

4. The method of claim 3, including after dispensing expandable slit sheet paper from said roll such that a diameter of said roll is reduced from said initial roll diameter, adjusting said frictional resistance applied to the expandable slit sheet paper that causes said expandable slit sheet paper to expand and form open cells by manually altering a path of the expandable slit sheet paper around said at least one bar such as to increase the frictional resistance applied to the expandable slit sheet paper.

5. The method of claim 4, wherein said manually altering a path of the expandable slit sheet paper around said at least one bar such as to increase the frictional resistance applied to the expandable slit sheet paper includes:
said at least one bar including a plurality of bars;
initially manually pulling a distal end of the roll of expandable slit sheet paper from a perimeter of said roll such that the expandable slit sheet paper extends along an arc around a portion of a periphery of a first bar of said plurality of bars, whereby applying a first frictional resistance to the expandable slit sheet paper that causes said expandable slit sheet paper to expand and form open cells; and
after dispensing expandable slit sheet paper from said roll such that a diameter of said roll is reduced from said initial diameter, manually redirecting the distal end of the roll of expandable slit sheet paper such that the expandable slit sheet paper extends along an arc around a portion of a periphery of one of said plurality of bars and then extends along an arc around a portion of a periphery of another of said plurality of bars, whereby applying a second frictional resistance to the expandable slit sheet paper, greater than said first frictional resistance, that causes said expandable slit sheet paper to expand and form open cells.

6. The method of claim 5, wherein said one of said plurality of bars is the same as said first bar of said plurality of bars.

7. The method of claim 3, including after dispensing expandable slit sheet paper from said roll such that a diameter of said roll is reduced from said initial diameter, adjusting said frictional resistance applied to the expandable slit sheet paper that causes said expandable slit sheet paper to expand and form open cells by adjusting a position of at least one of said at least one bars such as to increase the frictional resistance applied to the expandable slit sheet paper.

8. The method of claim 4, including after dispensing expandable slit sheet paper from said roll such that a diameter of said roll is reduced from said initial diameter, adjusting said frictional resistance applied to the expandable slit sheet paper that causes said expandable slit sheet paper to expand and form open cells by adjusting a position of at least one of said at least one bars such as to increase the frictional resistance applied to the expandable slit sheet paper.

9. The method of claim 7 or 8, wherein said at least one bar includes a pair of bars.

10. The method of claim 9, further including after dispensing expandable slit sheet paper from said roll such that a diameter of said roll is reduced from said initial diameter, adjusting a position of one of said pair of bars with respect to said frame.

11. The method of claim 9, further including after dispensing expandable slit sheet paper from said roll such that a diameter of said roll is reduced from said initial diameter, adjusting a position of each of said pair of bars with respect to said frame.

12. The method of claim 9, further including extending said expandable slit sheet paper in an S-curve configuration around said pair of bars, with said expandable slit sheet paper extending in respective arcs around at least portions of peripheries of each bar of said pair of bars.

13. The method of claim 9, further including extending said expandable slit sheet paper underneath and past a bottom of a lower one of said pair of bars, around a front side of said lower one of said pair of bars, backwardly between said pair of bars, and around and over the top of an upper one of said pair of bars.

14. The method of claim 7 or 8, wherein said bars have curved peripheries.

15. The method of claim 7 or 8, wherein said bars have substantially cylindrical peripheries.

16. The method of claim 14, wherein said bars are made with metal.

17. The method of claim 14, wherein said bars are non-rotatably supported on said frame.

18. The method of claim 14, wherein said bars are rotatably supported on said frame.

19. The method of claim 14, wherein said curved peripheries of said bars have friction surfaces that impart a frictional resistance to said expandable slit sheet paper.

20. A device for dispensing expandable slit sheet paper, comprising:
a roll of expandable slit sheet paper,
a frame configured to rotatably support the roll of expandable slit sheet paper;
at least one bar arranged to receive an end region of the expandable slit sheet paper such that the expandable slit sheet paper extends around a peripheral surface of said at least one bar that applies frictional resistance to the expandable slit sheet paper, whereby when the expandable slit sheet paper is manually pulled from a distal end of the expandable slit sheet paper said expandable slit sheet paper is expanded, and
wherein a position of the at least one bar relative to the frame is adjustable such as to adjust the frictional resistance applied to the expandable slit sheet paper.

21. The device of claim 20, wherein said at least one bar includes a pair of bars, said pair of bars being arranged such that the expandable slit sheet paper is passed in between said pair of bars.

22. The device of claim 21, wherein one of said pair of bars is movable with respect to said frame.

23. The device of claim 21, wherein each of said pair of bars is movable with respect to said frame.

24. The device of any of claims 22-23, wherein said expandable slit sheet paper is configured to follow an S-curve around said pair of bars.

25. The device of claim 24, wherein said expandable slit sheet paper is configured to extend underneath and past a bottom of a lower one of said pair of bars, around a front side of said lower one of said pair of bars, backwardly between said pair of bars, and around and over the top of an upper one of said pair of bars.

26. The device of claim 25, wherein the distal end of the expandable slit sheet paper is arranged to be manually grasped after passing around and over the top of the upper one of said pair of bars.

27. The device of any of claims 22-23, wherein said roll of expandable slit sheet paper is supported on a core that extends through a center of said roll, and wherein said frame includes at least one lateral side member configured to support said core.

28. The device of claim 27, wherein said frame includes two lateral side members configured to removably support opposite ends of said core.

29. The device of claim 28, wherein said lateral side members are made of metal.

30. A method of manually dispensing and expanding an expandable slit sheet paper, comprising:
providing a dispenser for expandable slit sheet material having at least one sidewall and having a plurality of bars supported on said at least one sidewall;
supporting a roll of expandable slit sheet paper on said frame, said roll of expandable slit sheet paper being wound around a central core member and having an initial diameter;
manually pulling a distal end of the roll of expandable slit sheet paper from a perimeter of said roll such that the expandable slit sheet paper extends along an arc around a portion of a periphery of a first of said plurality of bars, whereby applying a first frictional resistance to the expandable slit sheet paper causing said expandable slit sheet paper to expand and form open cells; and
after dispensing expandable slit sheet paper from said roll such that a diameter of said roll is reduced, manually redirecting the distal end of the roll of expandable slit sheet paper such that the expandable slit sheet paper extends along an arc around a portion of a periphery of one of said plurality of bars and then extends around an arc around a portion of a periphery of another of said plurality of bars, whereby applying a second frictional resistance applied to the expandable slit sheet paper, that is greater than said first frictional resistance, that causes said expandable slit sheet paper to expand and form open cells.
